(19) United States
(12) Patent Application Publication
(10) Pub. No.: US 2013/0194230 A1
(43) Pub. Date: Aug. 1, 2013

(54) SENSOR DEVICE, INPUT DEVICE, ELECTRONIC APPARATUS, AND INFORMATION PROCESSING METHOD

(71) Applicant: Sony Corporation, Tokyo (JP)

(72) Inventors: Hiroto Kawaguchi, Kanagawa (JP); Fumihiko Iida, Kanagawa (JP); Kei Tsukamoto, Kanagawa (JP); Toshio Kano, Kanagawa (JP); Takashi Itaya, Kanagawa (JP)

(73) Assignee: SONY CORPORATION, Tokyo (JP)

(21) Appl. No.: 13/748,020

(22) Filed: Jan. 23, 2013

(30) Foreign Application Priority Data
Jan. 27, 2012 (JP) 2012-015807
Jun. 27, 2012 (JP) 2012-144448

(51) Int. Cl. G06F 3/044

(52) U.S. Cl. CPC G06F 3/044
USPC 345/174

(57) ABSTRACT

A sensor device includes a capacitive element and an input operation unit. The capacitive element has a first surface and is configured to change a capacitance thereof by an approach of an operating element to the first surface. The input operation unit is arranged on the first surface. The input operation unit has a second surface on which an operation of the operating element is received and is configured to allow the operating element brought into contact with the second surface to move toward the first surface.

### CROSS REFERENCES TO RELATED APPLICATIONS

The present application claims priority to Japanese Priority Patent Application JP 2012-015807 filed in the Japan Patent Office on Jan. 27, 2012, and JP 2012-144448 filed in the Japan Patent Office on Jun. 27, 2012, the entire content of which is hereby incorporated by reference.

### BACKGROUND

The present disclosure relates to a sensor device including a capacitive element, an input device, an electronic apparatus, and an information processing method.

A touch-type input device including a capacitive element is known as an input device for an electronic apparatus. For example, Japanese Patent Application Laid-open No. 2011-197991 discloses an input device capable of detecting not only a touch operation of an operating element but also a push operation thereof.

### SUMMARY

In the technique disclosed in Japanese Patent Application Laid-open No. 2011-197991, however, the configuration of detecting a push operation of an operating element is adopted separately from the configuration of detecting whether a touch operation of an operating element is made or not. Therefore, in the above technique, the overall configuration of the input device is complicated.

In view of the circumstances as described above, it is desirable to provide a sensor device, an input device, and an electronic apparatus that have a simple configuration and are capable of detecting a touch operation and a push operation of an operating element.

According to an embodiment of the present disclosure, there is provided a sensor device including a capacitive element and an input operation unit.

The capacitive element has a first surface and is configured to change a capacitance thereof by an approach of an operating element to the first surface. The input operation unit is arranged on the first surface. The input operation unit has a second surface on which an operation of the operating element is received and is configured to allow the operating element brought into contact with the second surface to move toward the first surface.

With this configuration, the sensor device provides different amounts of capacitance change of the capacitive element between a touch operation and a push operation made with the operating element on the input operation unit.

The second surface may include a plurality of concave portions.

With this configuration, due to the push operation made with the operating element on the input operation unit, the operating element is elastically deformed and gets in the concave portions, to thereby approach the capacitive element.

The second surface may be formed of an elastic material.

With this configuration, due to the push operation made with the operating element on the input operation unit, the operating element is elastically deformed and gets in the concave portions and the elastic material is deformed. Thus, the operating element approaches the capacitive element.

The input operation unit may include an elastic body that forms the second surface.

With this configuration, due to a push operation made with the operating element on the input operation unit, the elastic body is deformed. Thus, the operating element approaches the capacitive element.

The input operation unit may be arranged between the first surface and the second surface and may further include a support portion configured to support the elastic body in an elastically deformable manner.

With this configuration, due to a push operation made with the operating element on the input operation unit, the elastic body is deformed. Thus, the operating element approaches the capacitive element.

According to another embodiment of the present disclosure, there is provided an input device including at least one sensor and a controller.

The at least one sensor includes a capacitive element and an input operation unit. The capacitive element has a first surface and is configured to change a capacitance thereof by an approach of an operating element to the first surface. The input operation unit is arranged on the first surface. The input operation unit has a second surface on which an operation of the operating element is received and is configured to allow the operating element brought into contact with the second surface to move toward the first surface. The controller includes a determination unit configured to determine a first state and a change from the first state to a second state based on a change of the capacitance of the capacitive element, the first state being a state in which the operating element is in contact with the second surface, the second state being a state in which the operating element is pressing the second surface.

With this configuration, in the input device, the determination unit of the controller can determine a touch operation and a push operation made with the operating element on the input operation unit based on the amount of capacitance change of the capacitive element.

The determination unit may be configured to determine the first state when an amount of capacitance change of the capacitive element is equal to or larger than a first threshold value, and determine the second state when the amount of capacitance change is equal to or larger than a second threshold value that is larger than the first threshold value.

With this configuration, the determination unit can easily distinguish between a touch operation and a push operation of the operating element, using the first threshold value and the second threshold value.

The at least one sensor may include a plurality of sensors, and the plurality of sensors may include a plurality of sensors each having a different second threshold value.

With this configuration, a so-called “key weight” at the time of a push operation can be changed for each sensor.

The input device may further include a storage configured to store data on the first threshold value and the second threshold value that are unique to the at least one sensor. The controller may be configured to control the storage to be capable of changing the data stored in the storage in response to an instruction from an outside.

With this configuration, the detection sensitivity of each sensor with respect to the touch and push operations can be changed.

The controller may further include a signal generation unit configured to generate an operation signal that is different between the first state and the second state.

With this configuration, the controller can cause an output device to perform a different action between the touch operation and the push operation made with the operating element on the input operation unit.

The at least one sensor may include a plurality of sensors, and the plurality of sensors may include a plurality of sensors each having a different detection sensitivity of the capacitive element with respect to the approach of the operating element.

Further, the plurality of sensors may include a plurality of sensors each having a different number of capacitive elements.

With this configuration, each of the plurality of sensors can adjust, based on the arrangement of the sensors on the input device or the like, the detection sensitivity thereof with respect to the touch and push operations of the operating element.

According to another embodiment of the present disclosure, there is provided an electronic apparatus including at least one sensor, a controller, a processing device, and an output device.

The at least one sensor includes a capacitive element and an input operation unit. The capacitive element has a first surface and is configured to change a capacitance thereof by an approach of an operating element to the first surface. The input operation unit is arranged on the first surface. The input operation unit has a second surface on which an operation of the operating element is received and is configured to allow the operating element brought into contact with the second surface to move toward the first surface. The controller includes a determination unit and a signal generation unit. The determination unit is configured to determine a first state and a change from the first state to a second state based on a change of the capacitance of the capacitive element, the first state being a state in which the operating element is in contact with the second surface, the second state being a state in which the operating element is pressing the second surface. The signal generation unit is configured to generate an operation signal that is different between the first state and the second state. The processing device is configured to generate a command signal based on the operation signal. The output device is configured to perform output based on the command signal.

With this configuration, in the input device, the output device can be caused to perform a different action between the touch operation and the push operation made with the operating element on the input operation unit.

The output device may include a display device configured to display an image based on the command signal.

With this configuration, the electronic apparatus can cause the input device to generate the operation signal and cause the display device to display an image that is based on the command signal by the operation signal.

The controller may be configured to determine the first state when the amount of capacitance change of the capacitive element is equal to or larger than the first threshold value and smaller than the second threshold value, and determine the second state when the amount of capacitance change is equal to or larger than the second threshold value.

With this configuration, whether each sensor is in the first state or the second state can be determined.

In the electronic apparatus, the at least one sensor may include a plurality of sensors. The electronic apparatus may further include a storage configured to store data on the first threshold value and the second threshold value that are unique to each of the plurality of sensors. The controller may be configured to control the storage to be capable of changing the data stored in the storage in response to an instruction from an outside.

According to another embodiment of the present disclosure, there is provided an information processing method using an electronic apparatus including at least one sensor including a capacitive element having a first surface and being configured to change a capacitance thereof by an approach of an operating element to the first surface, and an input operation unit arranged on the first surface, the input operation unit having a second surface on which an operation of the operating element is received and being configured to allow the operating element brought into contact with the second surface to move toward the first surface, the information processing method comprising: determining a first state in which the operating element is in contact with the second surface when an amount of capacitance change is equal to or larger than a first threshold value; and determining a second state in which the operating element is pressing the second surface when the amount of capacitance change is equal to or larger than a second threshold value that is larger than the first threshold value.

The information processing method may further include switching, based on an operation of a user, from an input operation mode in which the first state and the second state are determined to a change mode in which the second threshold value is changed.

Further, the at least one sensor may include a plurality of sensors, and the switching to the change mode may include changing the second threshold value of a part of the sensors to a value different from the second threshold values of the other sensors.

Furthermore, the changing the second threshold value may include receiving an input on the second threshold value of the part of the sensors and changing the second threshold value based on an input instruction value.

As described above, according to the present disclosure, it is possible to provide a sensor device, an input device, and an electronic apparatus that have a simple configuration and include a capacitive element capable of detecting a touch and a press of an operating element, and to provide an information processing method.

These and other objects, features and advantages of the present disclosure will become more apparent in light of the following detailed description of best mode embodiments thereof, as illustrated in the accompanying

Additional features and advantages are described herein, and will be apparent from the following Detailed Description and the figures.

### BRIEF DESCRIPTION OF THE FIGURES

FIG. 1 is a perspective view of an input device according to a first embodiment of the present disclosure;

FIGS. 2A to 2C are cross-sectional views of the input device taken along the line A-A′ shown in FIG. 1;

FIG. 3 is a block diagram of an electronic apparatus including the input device shown in FIG. 1;

FIGS. 4A to 4E are diagrams showing modified examples of an input operation unit shown in FIG. 1;

FIGS. 5A to 5J are diagrams showing modified examples of the input operation unit shown in FIG. 1;

FIGS. 6A to 6C are diagrams showing a method of manufacturing the input operation unit shown in FIG. 1;

FIGS. 7A to 7C are diagrams showing a modified example of the method of manufacturing the input operation unit;

FIGS. 8A to 8C are diagrams showing a modified example of the method of manufacturing the input operation unit;

FIG. 9 is a diagram showing the configuration of electrodes of the input device shown in FIG. 1;

FIG. 10 is a diagram showing a modified example of the configuration of electrodes of the input device;

FIG. 11 is a diagram showing an example of output signals of the input device shown in FIG. 1;

FIG. 12 is an explanatory diagram of a capacitance change speed of the input device shown in FIG. 1;

FIG. 13 is a plan view showing an example of the input device shown in FIG. 1;

FIG. 14 is a diagram showing a modified example of the configuration of electrodes of the input device;

FIG. 15 is a schematic diagram showing the configuration of a personal computer including the input device shown in FIG. 1;

FIG. 16 is a schematic diagram showing the configuration of the personal computer shown in FIG. 15;

FIG. 17 is a schematic diagram showing the configuration of the personal computer shown in FIG. 15;

FIG. 18 is a schematic diagram showing the configuration of the personal computer shown in FIG. 15;

FIGS. 19A and 19B are schematic diagrams each showing the configuration of a portable terminal apparatus including the input device shown in FIG. 1;

FIG. 20 is a schematic diagram showing the configuration of an imaging apparatus including the input device shown in FIG. 1;

FIGS. 21A and 21B are schematic diagrams each showing the configuration of a portable music player including the input device shown in FIG. 1;

FIGS. 22A and 22B are schematic diagrams each showing the configuration of a remote controller including the input device shown in FIG. 1;

FIGS. 23A and 23B are schematic diagrams each showing the configuration of a head-mounted display including the input device shown in FIG. 1, and showing an initial state in which a finger of a user is not approaching the input operation unit;

FIGS. 24A and 24B are schematic diagrams each showing the configuration of the head-mounted display including the input device shown in FIG. 1, and showing a state in which the user performs a touch operation;

FIGS. 25A and 25B are schematic diagrams each showing the configuration of the head-mounted display including the input device shown in FIG. 1, and showing a state in which the user performs a push operation;

FIGS. 26A to 26C are cross-sectional views of an input device according to a second embodiment of the present disclosure;

FIGS. 27A and 27B are enlarged cross-sectional views of an input operation unit shown in FIGS. 26A to 26C;

FIGS. 28A to 28C are cross-sectional views of an input device according to a third embodiment of the present disclosure;

FIGS. 29A to 29C are cross-sectional views of an input device according to a fourth embodiment of the present disclosure;

FIG. 30 is a block diagram of an input device according to a fifth embodiment of the present disclosure;

FIG. 31 is a partial cross-sectional view of the input device shown in FIG. 30;

FIG. 32 is a schematic cross-sectional view showing a manufacturing example of a capacitive element shown in FIG. 30;

FIG. 33 is a schematic cross-sectional view showing a manufacturing example of the capacitive element shown in FIG. 30;

FIG. 34 is a schematic cross-sectional view showing a manufacturing example of an input operation unit shown in FIG. 30;

FIG. 35 is a plan view of the input device shown in FIG. 30, showing only a wiring pattern of capacitive elements;

FIG. 36 is a plan view showing the configuration of first electrodes shown in FIG. 30;

FIG. 37 is a plan view showing the configuration of second electrodes shown in FIG. 30;

FIGS. 38A and 38B are diagrams for describing the action of the first and second electrodes shown in FIGS. 36 and 37, showing a configuration example of the first and second electrodes according to the fifth embodiment;

FIGS. 39A and 39B are diagrams for describing the action of the first and second electrodes shown in FIGS. 36 and 37, showing a configuration example of the first and second electrodes according to the related art;

FIGS. 40A to 40P are diagrams each showing a modified example of the first electrode shown in FIG. 36;

FIG. 41 is a flowchart of an operation example of the input device shown in FIG. 30;

FIG. 42 is a schematic top view of a sensor including two capacitive elements in sensors shown in FIG. 30;

FIG. 43 is a block diagram of an input device according to a sixth embodiment of the present disclosure;

FIG. 44 is a schematic cross-sectional view showing the configuration of a sensor shown in FIG. 43;

FIG. 45 is a schematic cross-sectional view of a sensor on which a metal plate is disposed, for explaining a method of detecting the sensitivity of capacitance change of capacitive elements shown in FIG. 43;

FIG. 46 is an example of a table showing the amounts of capacitance change of the capacitive elements shown in FIG. 43;

FIG. 47 is a schematic plan view showing an arrangement of capacitive elements in the case where the sensor shown in FIG. 43 includes four capacitive elements;

FIG. 48 is a diagram showing data examples on the setting of threshold values in the respective capacitive elements shown in FIG. 47;

FIGS. 49A and 49B are schematic cross-sectional views of the input device, for describing a setting example of threshold data;

FIGS. 50A and 50B are diagrams each showing a data example of sensitivity evaluation values of capacitive elements of a sensor shown in FIGS. 49A and 49B, which are based on the amounts of capacitance change from the initial capacitances;

FIG. 51 is a block diagram of an electronic apparatus according to a seventh embodiment of the present disclosure;

FIG. 52 is a diagram showing an example of a threshold-value setting image displayed on a monitor of the electronic apparatus shown in FIG. 51;

FIG. 53 is a diagram showing an example of the threshold-value setting image shown in FIG. 52, in which sensitivity evaluation values before change are displayed in predetermined cells;

FIG. 54 is a diagram showing an example of the threshold-value setting image shown in FIG. 52, in which sensitivity evaluation values after change are displayed in predetermined cells;

FIG. 55 is a schematic diagram showing a configuration example of an input device serving as the electronic apparatus shown in FIG. 51 and a tablet terminal;

FIG. 56 is a schematic diagram showing a configuration example of the input device serving as the electronic apparatus shown in FIG. 51 and the tablet terminal;

FIG. 57 is a schematic diagram showing a configuration example of the input device serving as the electronic apparatus shown in FIG. 51 and the tablet terminal;

FIGS. 58A and 58B are diagrams each showing a modified example of the input device shown in FIG. 30, showing a configuration example of the first electrode; and

FIGS. 59A to 59C are diagrams each showing a modified example of the input device shown in FIG. 30, showing a configuration example of the second electrode.

### DETAILED DESCRIPTION

Hereinafter, embodiments of the present disclosure will be described with reference to the drawings. The drawings show an X axis, a Y axis, and a Z axis that are orthogonal to one another. Those axes are common in the following embodiments.

### First Embodiment

(Overall Configuration)

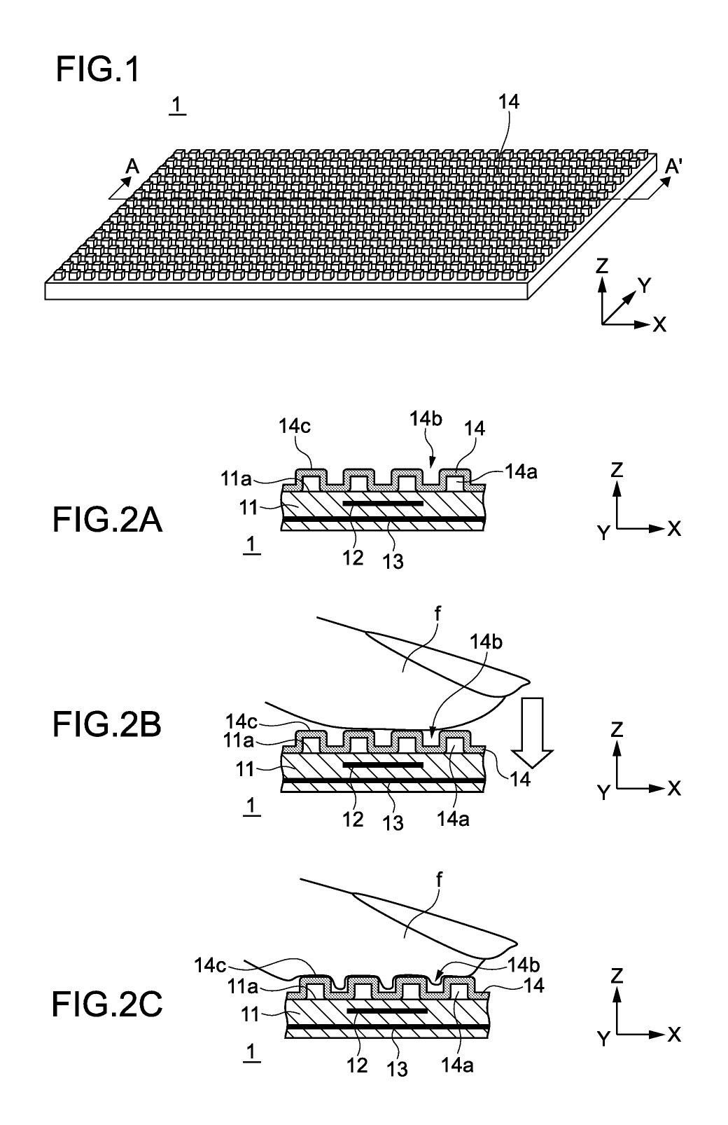

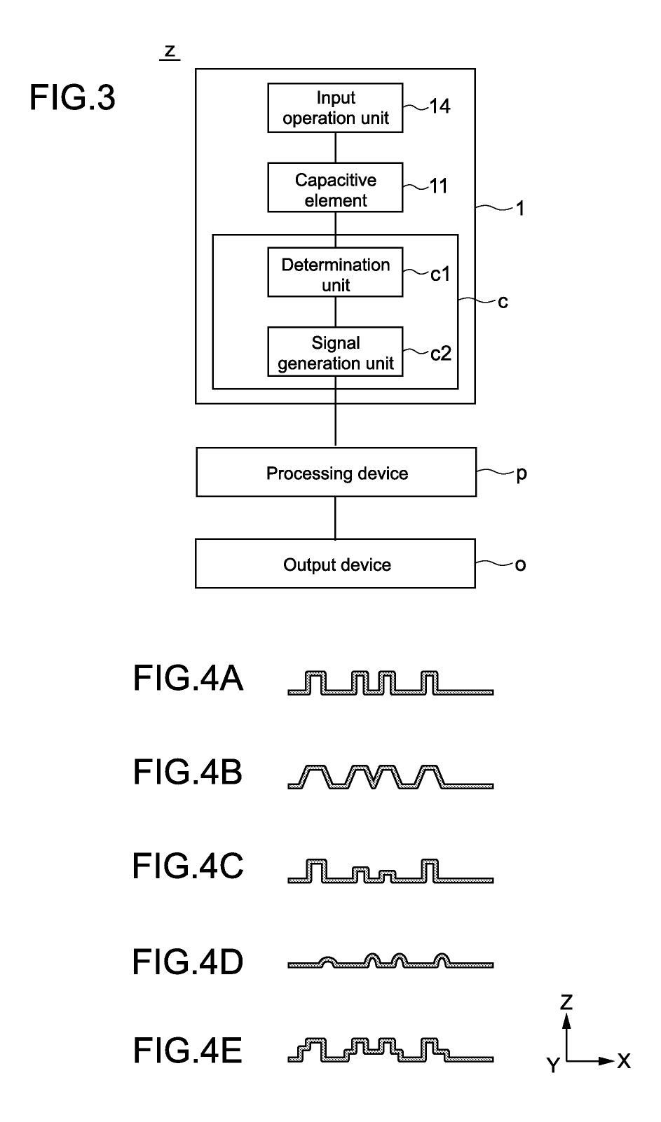

FIG. 1 is a perspective view of an input device 1 according to a first embodiment of the present disclosure. FIGS. 2A to 2C are partial cross-sectional views of the input device 1 taken along the line A-A′ shown in FIG. 1. FIG. 3 is a block diagram of an electronic apparatus z including the input device 1.

The input device 1 is formed to have a flat-plate shape and includes a capacitive element 11 and an input operation unit 14. The capacitive element 11 and the input operation unit 14 constitute a capacitive sensor device in a mutual capacitance system. The input operation unit 14 receives an operation of an operating element such as a finger. Hereinafter, a finger is taken as an example of the operating element. A capacitance of the capacitive element 11 varies due to the approach of a finger, which is associated with a touch operation and a push operation made with the finger on the input operation unit 14.

The input device 1 includes a controller c, and the controller c includes a determination unit c1 and a signal generation unit c2. The determination unit c1 determines what operation has been made on the input operation unit 14, based on the amount of capacitance change of the capacitive element 11 from a reference capacitance. The signal generation unit c2 generates an operation signal based on the determination of the determination unit c1.

The electronic apparatus z shown in FIG. 3 includes a processing device p and an output device o. The processing device p performs processing based on the operation signal generated by the signal generation unit c2 of the input device 1. The output device o is operated by the processing device p.

(Input Device)

As shown in FIGS. 2A to 2C, the capacitive element 11 has a first surface 11a on which the input operation unit 14 is formed, an X electrode 12, and a Y electrode 13. The X electrode 12 is arranged closer to the first surface 11a than the Y electrode 13 (on upper side in Z-axis direction).

The capacitive element 11 has a laminated structure of a plurality of base materials including a substrate on which the X electrode 12 is formed and a substrate on which the Y electrode 13 is formed. Examples of a material that forms the base materials include plastic materials made of PET (polyethylene terephthalate), PEN (polyethylene naphthalate), PI (polyimide), PC (polycarbonate), and the like.

The input operation unit 14 is formed of a sheet with a uniform thickness and bent to have a predetermined pattern. The input operation unit 14 has a second surface that is located on the opposite side of the first surface 11a of the capacitive element 11 and receives an operation of a finger f. The second surface of the input operation unit 14 is constituted of concave portions 14b and convex portions 14c. The concave portions 14b are each formed as a difference in level with respect to the convex portion 14c, the difference in level being formed in the Z-axis direction toward the capacitive element 11.

Portions where the concave portions 14b of the input operation unit 14 are formed are brought into contact with the first surface 11a of the capacitive element 11. Meanwhile, each of portions where the convex portions 14c of the input operation unit 14 are formed forms a space 14a between the first surface 11a of the capacitive element 11 and each convex portions 14c.

The input operation unit 14 is formed of an insulating material that is not deformed easily even when receiving an operation of the finger f. Examples of such a material include polyethylene terephthalate, a silicone resin, polyethylene, polypropylene, acrylic, polycarbonate, and a rubber material. The input operation unit 14 is formed of, for example, a film, a molded body, or a textile fabric made of the material described above.

FIG. 2B shows a touch state (first state) in which the input operation unit 14 receives a touch operation of the finger f. In the touch state, the finger f does not substantially exert a force on the input operation unit 14. It should be noted that the touch state includes a state in which the finger f exerts a tiny amount of force on the input operation unit 14 and a state in which the finger f is approaching the input operation unit 14. Due to the influence of the finger f as a conductor, the capacitance of the capacitive element 11 in the touch state shown in FIG. 2B is reduced to be lower than that of the capacitive element 11 in the state shown in FIG. 2A in which there is no influence of the finger f.

FIG. 2C shows a push state (second state) in which the input operation unit 14 receives a push operation of the finger f. In the push state shown in FIG. 2C, the finger f is pressed to the input operation unit 14 in the Z-axis direction from the touch state shown in FIG. 2B and then deformed to get into the concave portions 14b. Specifically, the finger fin the push state comes closer to the capacitive element 11 than in the touch state. For that reason, the capacitance of the capacitive element 11 in the push state shown in FIG. 2C is further reduced to be lower than that of the capacitive element 11 in the touch state shown in FIG. 2B.

It should be noted that the input device 1 may have a configuration capable of switching between a first mode in which the input device 1 operates in the touch state and does not operate in the push state, and a second mode in which the input device 1 operates in the push state and does not operate in the touch state. In this case, for example, a selector switch for changing the first mode and the second mode may be provided to the input device 1 or the processing device p.

(Input Operation Unit)

The amount of capacitance change when the touch state is changed into the push state depends on the depth in the Z-axis direction, at which the finger f gets into the concave portions 14b. In order that the determination unit c1 (see FIG. 3) determines the push state or the touch state, the amount of capacitance change has to be sufficiently large. Therefore, the depth of the concave portion 14b in the Z-axis direction with respect to the convex portion 14c is expected to be equal to or larger than a predetermined depth. On the other hand, in view of the demand for thinning of the input device 1, it is desirable for the depth of the concave portion 14b in the Z-axis direction with respect to the convex portion 14c to not exceed 1 mm. In this embodiment, the depth of the concave portion 14b in the Z-axis direction with respect to the convex portion 14c is set to the range from 100 μm to 300 μm. Further, the intervals between the convex portions 14c (length of each concave portion 14b in an X-axis direction and a Y-axis direction) are desirably nearly ten times as large as the depth of the concave portion 14b in the Z-axis direction with respect to the convex portion 14c.

The shape of the input operation unit 14 may be any other concavo-convex shape in addition to the concavo-convex shape shown in FIGS. 2A to 2C in which the convex portions 14c are continuously formed at regular intervals. For example, the shape of the input operation unit 14 may be any one of a concavo-convex shape as shown in FIG. 4A in which the intervals of convex portions differ in the X-axis direction, a concavo-convex shape as shown in FIG. 4B in which convex portions each have a tapered shape expanding toward the bottom of concave portions, a concavo-convex shape as shown in FIG. 4C in which convex portions are different in height, a concavo-convex shape as shown in FIG. 4D in which convex portions are formed of curved surfaces, and a concavo-convex shape as shown in FIG. 4E in which multi-level convex portions are formed.

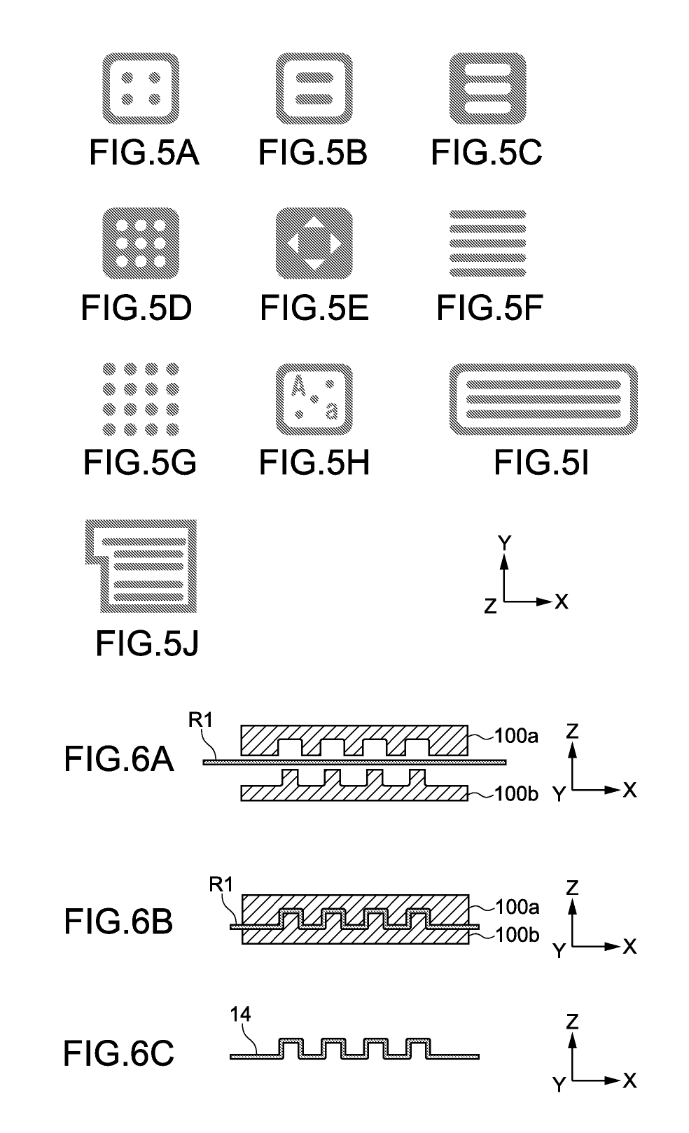

The concavo-convex pattern on the X-Y plane of the input operation unit 14 is not limited to the pattern as shown in FIG. 1 in which cuboids are arranged, and may be any other patterns. For example, each of the shapes shown in FIGS. 5A to 5J, in which black parts correspond to convex portions and white parts correspond to concave portions, may be used as a unit to form a pattern including such shapes continuously arranged.

Specifically, the shapes described above may be a shape as shown in FIG. 5A, which includes a rectangular wall portion and four columnar portions formed at four corners inside the wall portion, a shape as shown in FIG. 5B, which includes a rectangular first wall portion and two second wall portions inwardly formed along two opposed sides of the first wall portion, and a shape as shown in FIG. 5C, in which both ends of the second wall portions of FIG. 5B extending in a longitudinal direction are continuous with the first wall portion. Further, the shapes described above may be a shape as shown in FIG. 5D, in which a plurality of holes are formed in a rectangular block portion, and a shape as shown in FIG. 5E, in which a plurality of multiangular-shaped concave portions are formed in a rectangular block portion. Further, the shapes described above may be a shape as shown in FIG. 5F, which includes wall portions formed parallel to each other at regular intervals, and a shape as shown in FIG. 5G, which includes columnar portions formed at regular intervals. In addition, the shapes described above may be a shape as shown in FIG. 5H, which includes embossed characters, a shape as shown in FIG. 5I, which includes flat wall portions, and a shape as shown in FIG. 5J, which includes multiangular-shaped wall portions.

The input operation unit 14 may have a shape in which the convex portions and the concave portions in the patterns described above are inverted.

(Method of Manufacturing Input Operation Unit)

FIGS. 6A to 6C are diagrams showing a method of manufacturing the input operation unit 14 of the input device 1 according to this embodiment. As shown in FIG. 6A, a sheet-like resin R1 that forms the input operation unit 14 is first prepared. As shown in FIG. 6B, the resin R1 is interposed between an upper die 100a having a predetermined concave pattern and a lower die 100b having a convex pattern that engages with the upper die 100a so that the resin R1 is subjected to press forming in a heated state. Then, as shown in FIG. 6C, the resin R1 is released from the upper die 100a and the lower die 100b to obtain the input operation unit 14.

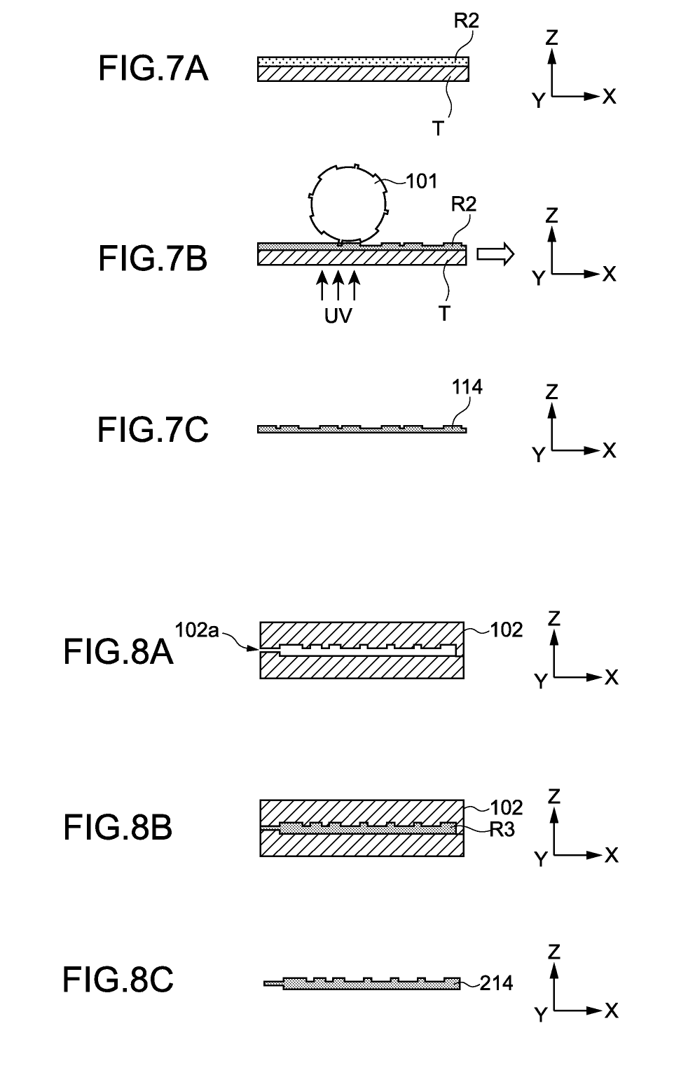

FIGS. 7A to 7C are diagrams showing a modified example of the method of manufacturing the input operation unit. As shown in FIG. 7A, an UV (ultraviolet) resin R2 is first disposed on a transparent plate T. A solid sheet material or a liquid UV curable material may be used as the resin R2. As shown in FIG. 7B, using a roll-shaped die 101 having a predetermined concavo-convex pattern, the concavo-convex pattern of the die 101 is transferred to the UV resin R2, and the UV resin R2 is subjected to UV irradiation from the transparent plate T side so as to be cured. As shown in FIG. 7C, the UV resin R2 is separated from the transparent plate T to obtain an input operation unit 114.

FIGS. 8A to 8C are also diagrams showing a modified example of the method of manufacturing the input operation unit. As shown in FIG. 8A, an injection-molding mold 102 having a predetermined shape is first prepared. As shown in FIG. 8B, a thermoplastic resin R3 in a molten state is injected into the mold 102 from an injection port 102a, thus performing injection molding of the resin R3. As shown in FIG. 8C, the resin R3 is released from the injection-molding mold 102 to obtain an input operation unit 214.

(Configuration of Electrode of Capacitive Element)

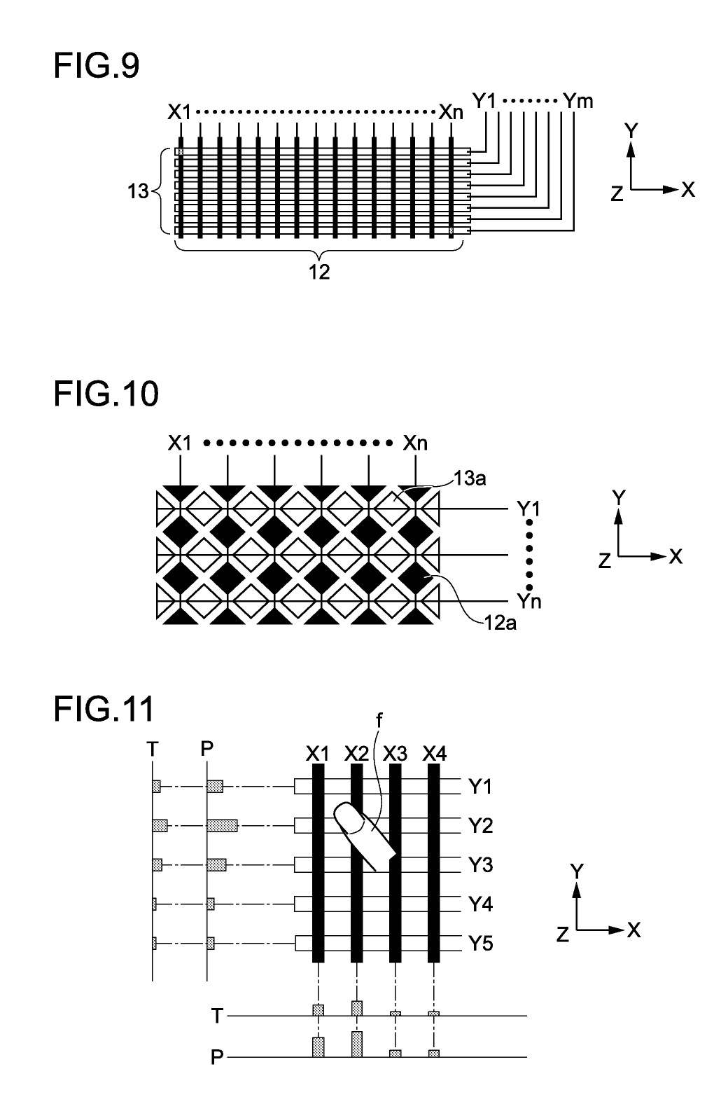

FIG. 9 is a plan view of the input device 1 viewed in the Z-axis direction, showing only the X electrodes 12 and the Y electrodes 13 in the capacitive element 11. The X electrodes 12 and the Y electrodes 13 are formed in a so-called cross-matrix. The input device 1 includes n columns of the X electrodes 12 extending over the entire range of the input device 1 in the Y-axis direction, and m rows of the Y electrodes 13 extending over the entire range of the input device 1 in the X-axis direction. The X electrodes 12 are arranged over the entire range of the input device 1 in the X-axis direction, and the Y electrodes 13 are arranged over the entire range of the input device 1 in the Y-axis direction. It should be noted that the electrodes may not be necessarily arranged at regular intervals, and a pitch in the arrangement may be changed in accordance with the positions of respective keys.

In the input device 1, the capacitive elements 11 shown in FIGS. 2A to 2C are formed at positions at which the X electrodes 12 and the Y electrodes 13 cross each other. Accordingly, the input device 1 includes n*m pieces of capacitive elements 11. In the case of input devices each including the input operation unit 14 having the same area, an input device having larger values of n and m has a higher density of the capacitive elements 11 on the X-Y plane, and accordingly an operation position can be detected more accurately.

It should be noted that the input device 1 according to this embodiment adopts a mutual capacitance system, but a self-capacitance system may be adopted in the case of a single-touch system in which operations to the input operation unit 14 are not simultaneously made at a plurality of positions, not in the case of a multi-touch system.

FIG. 10 is a diagram showing the configuration of electrodes in the case where the self-capacitance system is adopted. X electrodes 12a and Y electrodes 13a are rhomboid electrodes that are arranged so as not to overlap each other in the Z-axis direction. The X electrodes 12a form n columns extending in the Y-axis direction, and the Y electrodes 13a form m rows extending in the X-axis direction. It should be noted that in the case where the self-capacitance system is adopted for the input device 1, the capacitance of the capacitive element 11 in the touch state shown in FIG. 2B is higher than that of the capacitive element 11 in the state shown in FIG. 2A, and the capacitance of the capacitive element 11 in the push state shown in FIG. 2C is higher than that of the capacitive element 11 in the touch state shown in FIG. 2B.

(Controller)

The controller c is typically constituted of a CPU (Central Processing Unit) or an MPU (Micro-Processing Unit). In this embodiment, the controller c includes the determination unit c1 and the signal generation unit c2 and executes various functions according to programs stored in a storage (not shown). The determination unit c1 determines the state of the input operation unit 14 based on electrical signals that are output from the capacitive elements 11. The signal generation unit c2 generates an operation signal based on a determination result of the determination unit c1. Further, the controller c includes a drive circuit for driving the input device 1. The drive circuit outputs a drive signal to each of the capacitive elements 11 at predetermined time intervals. The controller c further includes an output determination circuit that processes the output from each of the capacitive elements 11 with respect to the drive signal and determines an input operation from the input device 1 operated by a user.

FIG. 11 is a diagram showing an example of output signals from the capacitive elements 11. Bars shown along the X axis of FIG. 11 each indicate the amount of capacitance change based on a reference capacitance of any capacitive element 11 formed by each X electrode 12. Bars shown along the Y axis of FIG. 11 each indicate the amount of capacitance change based on a reference capacitance of any capacitive element 11 formed by each Y electrode 13. Here, the reference capacitance refers to a capacitance of the capacitive element 11 in a state shown in FIG. 2A, which is free from the influence of the finger f. The bars are divided into the touch state (denoted by “T”) shown in FIG. 2B and the push state (denoted by “P”) shown in FIG. 2C.

The determination unit c1 of the controller c shown in FIG. 3 calculates coordinates in the X-axis direction and the Y-axis direction of the operation position of the finger f on the input operation unit 14, based on the amounts of capacitance change obtained from the X electrodes 12 and the Y electrodes 13. Specifically, in FIG. 11, the determination unit c1 calculates an X coordinate of the operation position of the finger f based on a ratio of the amounts of capacitance change of the capacitive elements 11 formed by the X electrodes 12 (X1, X2, X3, X4), and calculates a Y coordinate of the operation position of the finger f based on a ratio of the amounts of capacitance change of the capacitive elements 11 formed by the Y electrodes 13 (Y1, Y2, Y3, Y4). Thus, the determination unit c1 outputs the coordinates of the operation position on the input operation unit 14 to the signal generation unit c2 (see FIG. 3).

The determination unit c1 may use, as an evaluation value indicating the touch state shown in FIG. 2B or the push state shown in FIG. 2C, the maximum value of the amounts of capacitance change of the capacitive elements 11 formed by the X electrodes 12 or the Y electrodes 13.

Further, the determination unit c1 may use, as an evaluation value indicating the touch state shown in FIG. 2B or the push state shown in FIG. 2C, a combined value of the amounts of capacitance change of the capacitive elements 11 formed by the X electrodes 12 (hereinafter, referred to as X combined value that is a combined value of values of the respective bars shown along the X axis in FIG. 11). Instead of the X combined value, the determination unit c1 may use a combined value of the amounts of capacitance change of the capacitive elements 11 formed by the Y electrodes 13 (hereinafter, referred to as Y combined value that is a combined value of values of the respective bars shown along the Y axis in FIG. 11). Alternatively, instead of the X combined value or the Y combined value, the determination unit c1 may use a value obtained by further combining the X combined value and the Y combined value.

Specifically, a first threshold value and a second threshold value larger than the first threshold value are set in the determination unit c1. The determination unit c1 determines the touch state when the evaluation value is equal to or larger than the first threshold value and smaller than the second threshold value, and determines the push state when the evaluation value is equal to or larger than the second threshold value. Then, the determination unit c1 outputs the determination result to the signal generation unit c2 (see FIG. 3).

Any value may be set for the first threshold value and the second threshold value in the determination unit c1. For example, the first threshold value and the second threshold value may be set to a small value for users such as women and children whose finger force is weak or may be set to a large value for users whose finger force is strong. In the case of users with large fingers, an area of a finger coming into contact with the input operation unit 14 is large compared with users with small fingers. In this case, the amount of capacitance change of the capacitive element 11 increases in both the touch state and the push state. Therefore, the first threshold value and the second threshold value can be set to be large for the users with large fingers.

Incidentally, the determination unit c1 reads the amount of capacitance change of the capacitive element 11 at intervals of a predetermined period of time Ts (generally, 15 msec or 20 msec). In the case where the operation of the finger f on the input operation unit 14 continues for the predetermined period of time Ts or more, the determination unit c1 can read the accurate amount of capacitance change. On the other hand, the determination unit c1 may have the difficulty of reading the accurate amount of capacitance change with respect to a brief operation of the finger f on the input operation unit 14.

In particular, in the case where the input device 1 is used as a keyboard for a personal computer, the finger f being softly placed on the input operation unit 14 is pushed into a portion corresponding to a key of the input operation unit 14. Therefore, if the determination unit c1 has the difficulty of determining the touch state or the push state accurately, typing errors occur frequently. In addition, the keyboard for a personal computer is expected to be capable of inputting ten characters per second. Therefore, in order to read an accurate amount of capacitance change, a reading speed of the determination unit c1 is insufficient.

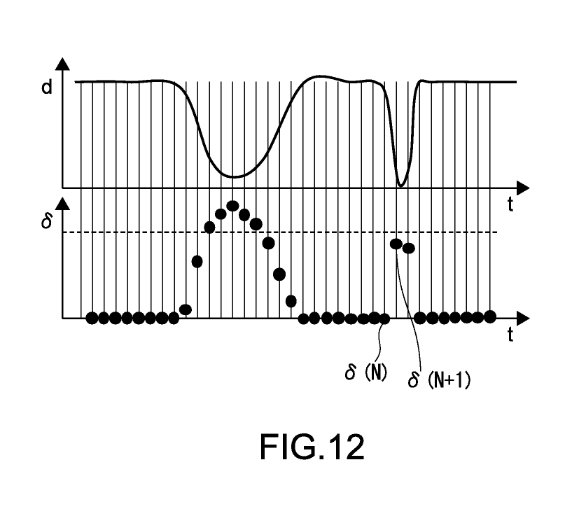

FIG. 12 is a graph showing a time change of a distance d between the finger f and the capacitive element 11 (upper part of FIG. 12) and a time change of a value δ of the amount of capacitance change of the capacitive element 11, which is read by the determination unit c1 (lower part of FIG. 12) (hereinafter, referred to as read value δ). A time axis t is common in both the parts of FIG. 12. Intervals between vertical solid lines of FIG. 12 correspond to time intervals at which the determination unit c1 described above reads the amount of capacitance change. Further, in the lower part of FIG. 12, the above-mentioned second threshold value of the amount of capacitance change is shown by broken lines.

In the upper part of FIG. 12, two bottoms are formed, and the input device 1 is put into the push state twice in the period of time shown in FIG. 12. The determination unit c1 detects the first push state in which the read value δ exceeds the second threshold value. On the other hand, in the second push state, the maximum value of the actual amount of capacitance change exceeds the second threshold value, but the read value δ of the amount of capacitance change in the determination unit c1 does not exceed the second threshold value. This is because a brief operation of the finger f on the input operation unit 14 is performed and the amount of capacitance change is turned to be maximum between two timings (vertical solid lines adjacent to each other) at which the determination unit c1 reads the amount of capacitance change.

To prevent the determination unit c1 from failing to determine the touch state or the push state in such a case, the determination unit c1 calculates a capacitance change speed V based on two read values δ of the amount of capacitance change, which are continuously obtained.

The determination unit c1 calculates the capacitance change speed V by the following expression using, for example, out of the read values δ of the amount of capacitance change, a read value δ(N) and a read value δ(N+1) that are continuous at N-th time and (N+1)-th time and the above-mentioned predetermined period of time Ts.

V=[δ(N+1)−δ(N)]/Ts

A third threshold value and a fourth threshold value larger than the third threshold value are set for the determination unit c1. The determination unit c1 determines the touch state when the capacitance change speed V is equal to or larger than the third threshold value and smaller than the fourth threshold value, and determines the push state when the capacitance change speed V is equal to or larger than the fourth threshold value.

With such a configuration, in the input device 1, the touch state or the push state is also precisely determined when a brief operation of the finger f is made on the input operation unit 14. Any value may be set as the third threshold value and the fourth threshold value in the determination unit c1 as in the case of the first threshold value and the second threshold value.

In this manner, in the input device 1 according to this embodiment, the determination unit c1 can accurately determine the touch state or the push state.

The signal generation unit c2 generates an operation signal in accordance with an output signal from the determination unit c1. Specifically, the signal generation unit c2 generates an operation signal that is different between the touch state and the push state.

As described above, the input device 1 according to this embodiment does not have a mechanical structure and accordingly has a long useful life and excellent waterproof property.

(Electronic Apparatus)

(Personal Computer)

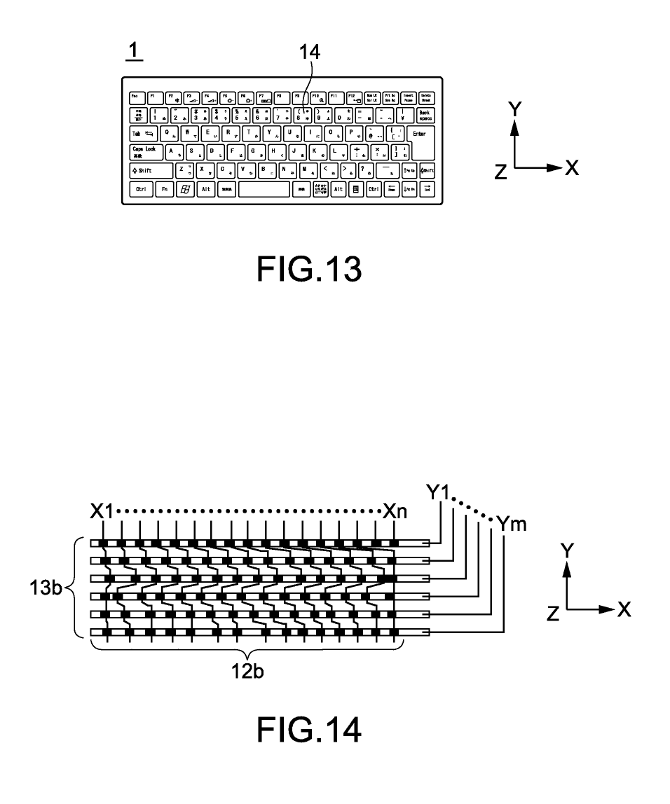

An example in which the input device 1 according to this embodiment is applied to a personal computer will be described. FIG. 13 is a top view of the input device 1. Characters or designs are drawn on the input operation unit 14 in a key arrangement similar to that of a keyboard for a commonly-used personal computer.

In this example, the configuration of electrodes shown in FIG. 9 may be changed to that of FIG. 14. In the configuration of electrodes shown in FIG. 14, X electrodes 12b and Y electrodes 13b are arranged such that the capacitive elements 11 correspond to the respective keys. With this configuration, the position of an operated key is precisely determined by the determination unit c1.

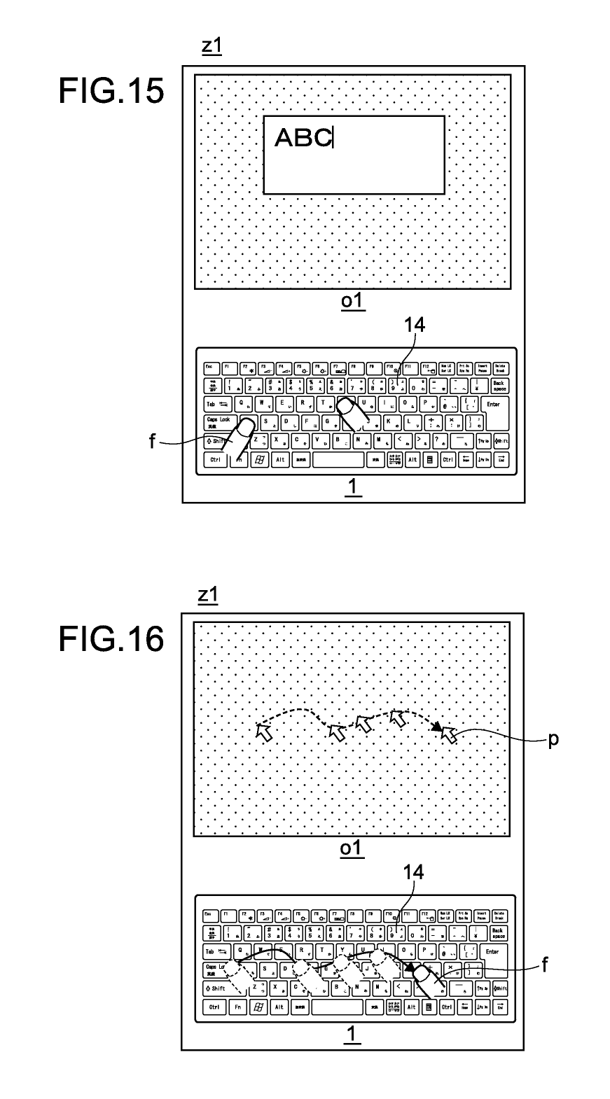

FIGS. 15 to 18 are schematic diagrams each showing the configuration of a personal computer z1 serving as the electronic apparatus z (see FIG. 3) that includes the input device 1 according to this embodiment and a display device o1 serving as the output device o (see FIG. 3). The personal computer z1 includes a processing device p (not shown) (see FIG. 3).

In the case where the personal computer z1 is of a desktop type, the input device 1 is configured separately from a main body as the processing device p and the display device o1. The main body and the display device o1 may be configured integrally or separately. Further, the input device 1 may be connected to the main body and the display device o1 by a cable or radio waves.

On the other hand, in the case where the personal computer z1 is of a notebook type, the input device 1, the processing device p, and the display device o1 may be configured integrally. In this case, the controller c of the input device 1 may also serve as the processing device p.

A description will be given on FIG. 15. When a push operation of applying a pressing force to a position of an X-axis (first-axis) coordinate and a Y-axis (second-axis) coordinate that correspond to each key of the input operation unit 14 is made with the finger f, the determination unit c1 of the input device 1 determines that the position of the key is put into the push state and outputs a determination result to the signal generation unit c2 of the input device 1. Thus, the signal generation unit c2 generates an operation signal for display corresponding to a character or a design of the key at the position that is put into the push state, and outputs the operation signal to the processing device p. The processing device p generates a command signal based on the operation signal, and the display device o1 displays an image based on the command signal. In this manner, the input device 1 can be used similarly to a keyboard for a commonly-used personal computer.

Next, a description will be given on FIG. 16. When a touch operation of moving on the input operation unit 14 is made with the finger f being in contact with the input operation unit 14, the determination unit c1 of the input device 1 determines that a position corresponding to a movement locus of the finger f is put into the touch state, and outputs a determination result to the signal generation unit c2 of the input device 1. Thus, the signal generation unit c2 generates an operation signal for moving a pointer p based on the movement locus of the finger f, and outputs the operation signal to the processing device p. The processing device p generates a command signal based on the operation signal, and the display device o1 moves the pointer p based on the command signal. In this manner, in the input device 1, a pointer can be moved intuitively as in the case of a mouse or trackpad for a commonly-used personal computer.

Further, when the input operation unit 14 receives a push operation in a state in which the pointer p is on an icon (not shown) in the display device o1, the determination unit c1 of the input device 1 determines that the input operation unit 14 is put into the push state, and outputs a determination result to the signal generation unit c2 of the input device 1. Thus, the signal generation unit c2 generates an operation signal with which the icon is put into a selected state, and outputs the operation signal to the processing device p. The processing device p generates a command signal based on the operation signal, and the display device o1 puts the icon into a selected state based on the command signal. In this manner, the input device 1 has a function corresponding to a click or tap of a mouse or trackpad for a commonly-used personal computer.

Furthermore, when the input operation unit 14 receives push operations two successive times in a state in which the pointer p is on an icon in the display device o1, the determination unit c1 of the input device 1 determines that the input operation unit 14 is put into a short-time push state two successive times, and outputs a determination result to the signal generation unit c2 of the input device 1. Thus, the signal generation unit c2 generates an operation signal for opening the icon and outputs the operation signal to the processing device p. The processing device p generates a command signal based on the operation signal, and the display device o1 opens the icon based on the command signal. In this manner, the input device 1 has a function corresponding to a double click or double tap of a mouse or a trackpad for a commonly-used personal computer.

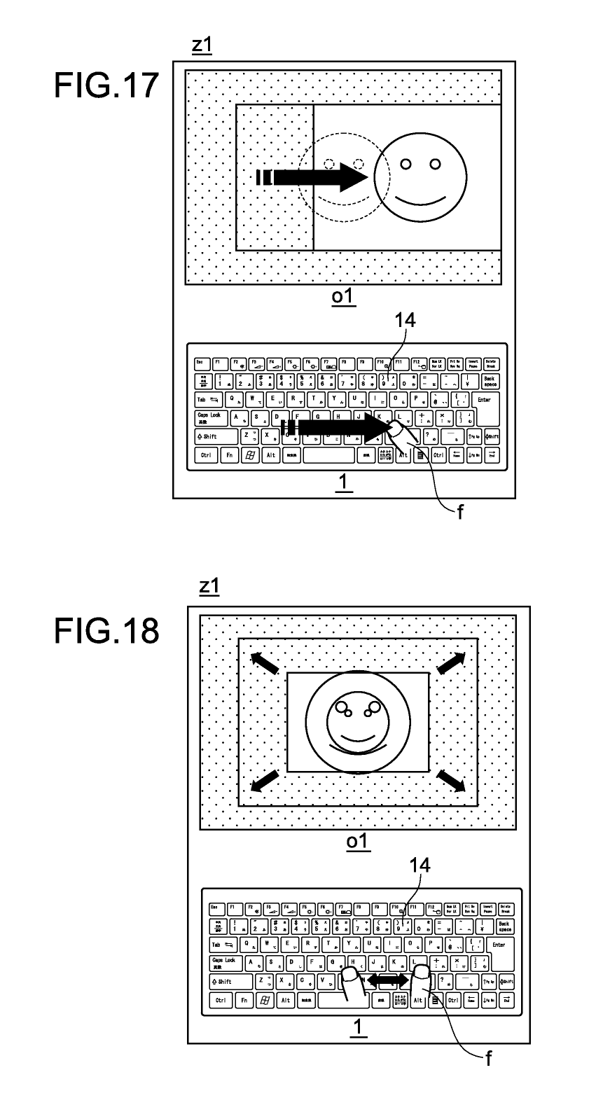

Next, a description will be given on FIG. 17. When a touch operation of quickly moving on the input operation unit 14 within a short time (also referred to as “swipe operation” or “flick operation”) is made with the finger f being in contact with the input operation unit 14, the determination unit c1 of the input device 1 detects a movement direction of the operation position in the touch state and outputs a detection result to the signal generation unit c2 of the input device 1. Thus, the signal generation unit c2 generates an operation signal for moving an image based on the movement direction of the operation position and outputs the operation signal to the processing device p. The processing device p generates a command signal based on the operation signal, and the display device o1 moves the image based on the command signal. Further, the input device 1 can perform an operation of turning over pages of an electronic book displayed on the display device o1 by a similar operation. Furthermore, the input device 1 can also perform an operation of changing a screen displayed on the display device o1 to another screen by a similar operation.

Next, a description will be given on FIG. 18. When a touch operation of separating two fingers f being in contact with the input operation unit 14 from each other (also referred to as “pinch-out operation”) is made on the input operation unit 14, the determination unit c1 of the input device 1 detects that operation positions in the touch state are being moved so as to be separate from each other, and outputs a detection result to the signal generation unit c2 of the input device 1. Thus, the signal generation unit c2 generates an operation signal for zooming in an image and outputs the operation signal to the processing device p. The processing device p generates a command signal based on the operation signal, and the display device o1 zooms in the image based on the command signal.

Similarly, when a touch operation of closing the two fingers f being in contact with the input operation unit 14 (also referred to as “pinch-in operation”) is made on the input operation unit 14, the determination unit c1 of the input device 1 detects that operation positions in the touch state are moved so as to come close to each other, and outputs a detection result to the signal generation unit c2 of the input device 1. Thus, the signal generation unit c2 generates an operation signal for zooming out an image and outputs the operation signal to the processing device p. The processing device p generates a command signal based on the operation signal, and the display device o1 zooms out the image based on the command signal.

As described above, the input device 1 according to this embodiment has both functions of a keyboard and a pointing device in the personal computer z1. The input device 1 may be configured such that a mode used as a keyboard and a mode used as a pointing device may be switched. In this case, for example, a mode selector switch may be provided to the input device 1 or the processing device p.

Hereinabove, an example of the functions of the input device 1 in the personal computer z1 has been described, but the input device 1 can achieve any function of a commonly-used input device such as a keyboard, a mouse, a trackpad, and a touch panel. For example, a document or a browser displayed on the display device o1 can be scrolled by an operation similar to that performed in the commonly-used input device described above.

(Portable Terminal Apparatus)

A description will be given on an example in which the input device 1 according to this embodiment is applied to a portable terminal apparatus.

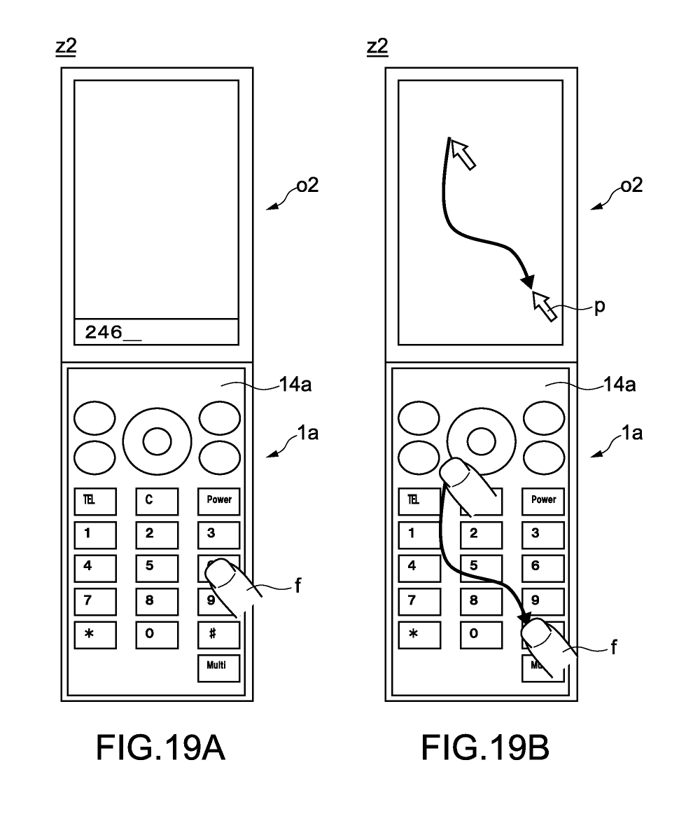

FIGS. 19A and 19B are schematic diagrams each showing the configuration of a portable terminal apparatus z2 serving as the electronic apparatus z (see FIG. 3) that includes the input device 1 according to this embodiment and a display device o2 serving as the output device o (see FIG. 3). The portable terminal apparatus z2 may include the processing device p (not shown) (see FIG. 3). The controller c of the input device 1 may also serve as the processing device p, or the display device o2 may include the processing device p.

Characters or designs are drawn on the input operation unit 14 in a key arrangement similar to that of a commonly-used portable terminal apparatus. The input device 1 and the display device o2 may be configured integrally or separately. Further, the portable terminal apparatus z2 may be configured to be foldable such that the input operation unit 14 of the input device 1 and a display screen of the display device o2 are brought close to each other.

A description will be given on FIG. 19A. When a push operation of applying a pressing force to a position corresponding to each key of the input operation unit 14 is made with the finger f, the determination unit c1 of the input device 1 determines that the position of the key is put into the push state, and outputs a determination result to the signal generation unit c2 of the input device 1. Thus, the signal generation unit c2 generates an operation signal for display corresponding to a character or a design of the key at the position that is put into the push state, and outputs the operation signal to the processing device p. The processing device p generates a command signal based on the operation signal, and the display device o2 displays an image based on the command signal. In this manner, the input device 1 can be used similarly to a numeric keypad for a commonly-used portable terminal apparatus.

Next, a description will be given on FIG. 19B. When a touch operation of moving on the input operation unit 14 is made with the finger f being in contact with the input operation unit 14, the determination unit c1 of the input device 1 determines that a position corresponding to a movement locus of the finger f is put into the touch state, and outputs a determination result to the signal generation unit c2 of the input device 1. Thus, the signal generation unit c2 generates an operation signal for moving the pointer p based on the movement locus of the finger f, and outputs the operation signal to the processing device p. The processing device p generates a command signal based on the operation signal, and the display device o2 moves the pointer p based on the command signal. In this manner, in the input device 1, a pointer can be moved intuitively.

Hereinabove, an example of the function of the input device 1 in the portable terminal apparatus z2 has been described, but the input device 1 can achieve any function of a commonly-used input device such as a numeric keypad and a touch panel. For example, a document or a browser displayed on the display device o2 can be scrolled by an operation similar to that performed in the commonly-used input device described above.

(Imaging Apparatus)

A description will be given on an example in which the input device 1 according to this embodiment is applied to an imaging apparatus.

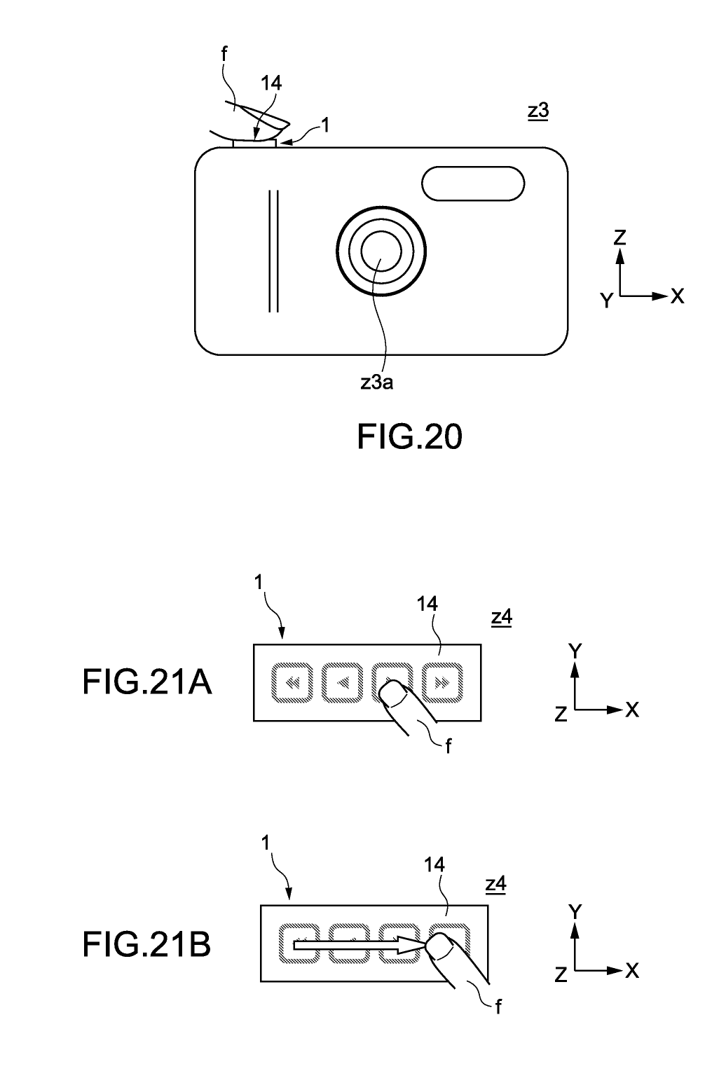

FIG. 20 is a schematic diagram showing the configuration of an imaging apparatus z3 serving as the electronic apparatus z (see FIG. 3) that includes the input device 1 according to this embodiment and a lens z3a. The imaging apparatus z3 includes an imaging mechanism (not shown) serving as the output device o (see FIG. 3) and a recording unit configured to store a captured image. The input device 1 is a shutter device including a single capacitive element 11. The imaging apparatus z3 may include the processing device p (not shown) (see FIG. 3). The controller c of the input device 1 may also serve as the processing device p. Therefore, each of the values of n and m shown in FIG. 9 is 1, and an evaluation value of the determination unit c1 in the example shown in FIG. 11 is only one.

When a touch operation of touching the input operation unit 14 is made with the finger f, the determination unit c1 of the input device 1 determines that the state is put into the touch state, and outputs a determination result to the signal generation unit c2 of the input device 1. Thus, the signal generation unit c2 generates an operation signal for putting the imaging mechanism into a state in which a shutter button is pressed halfway, and outputs the operation signal to the processing device p. The processing device p generates a command signal based on the operation signal so that the imaging mechanism is put into the state in which the shutter button is pressed halfway based on the command signal and an image taken from the lens z3a is brought into focus.

When a push operation of applying a pressing force to the input operation unit 14 is made with the finger f, the determination unit c1 of the input device 1 determines that the state is put into the push state, and outputs a determination result to the signal generation unit c2 of the input device 1. Thus, the signal generation unit c2 generates an operation signal for putting the imaging mechanism into a state in which a shutter button is pushed in, and outputs the operation signal to the processing device p. The processing device p generates a command signal based on the operation signal so that the imaging mechanism is put into the state in which shutter button is pushed in based on the command signal, and the image taken from the lens z3a is recorded in the recording unit.

(Portable Music Player)

A description will be given on an example in which the input device 1 according to this embodiment is applied to a portable music player.

FIGS. 21A and 21B are schematic diagrams each showing the configuration of a portable music player z4 serving as the electronic apparatus z (see FIG. 3). The portable music player z4 includes the input device 1 according to this embodiment and a recording unit (not shown) configured to store audio data. The portable music player z4 may include the processing device p (not shown) (see FIG. 3). The controller c of the input device 1 may also serve as the processing device p. Earphones serving as the output device o (see FIG. 3) are connected to the portable music player z4. The output device o is not limited to the earphones, but may be headphones, a speaker, or the like. Designs are drawn on the input operation unit 14 in a key arrangement similar to that of a commonly-used portable music player.

A description will be given on FIG. 21A. When a push operation of applying a pressing force to a position corresponding to each key of the input operation unit 14 is made with the finger f, the determination unit c1 of the input device 1 determines that the position of the key is put into the push state, and outputs a determination result to the signal generation unit c2 of the input device 1. Thus, the signal generation unit c2 generates an operation signal for performing an operation (for example, “reproduction” or “fast-forward”) corresponding to a design of the key at the position being in the push state, and outputs the operation signal to the processing device p. The processing device p generates a command signal based on the operation signal, and the earphones output audio data based on the command signal.

Next, a description will be given on FIG. 21B. When a touch operation of moving quickly in a short time on the input operation unit 14 is made with the finger f being in contact with the input operation unit 14 toward the right in the X axis (first axis) direction, the determination unit c1 of the input device 1 detects a movement direction of the operation position in the touch state and outputs a detection result to the signal generation unit c2 of the input device 1. Thus, the signal generation unit c2 generates an operation signal for increasing a volume of sound based on the movement direction of the operation position and outputs the operation signal to the processing device p. The processing device p generates a command signal based on the operation signal, and the earphones increase the volume of sound of audio data to be output, based on the command signal.

Conversely, when a touch operation of moving quickly in a short time on the input operation unit 14 is made with the finger f being in contact with the input operation unit 14 toward the left in the X axis direction, the determination unit c1 of the input device 1 detects a movement direction of the operation position in the touch state and outputs a detection result to the signal generation unit c2 of the input device 1. Thus, the signal generation unit c2 generates an operation signal for reducing the volume of sound based on the movement direction of the operation position and outputs the operation signal to the processing device p. The processing device p generates a command signal based on the operation signal and the earphones reduce the volume of sound of audio data to be output, based on the command signal.

(Remote Controller)

A description will be given on an example in which the input device 1 according to this embodiment is applied to a remote controller.

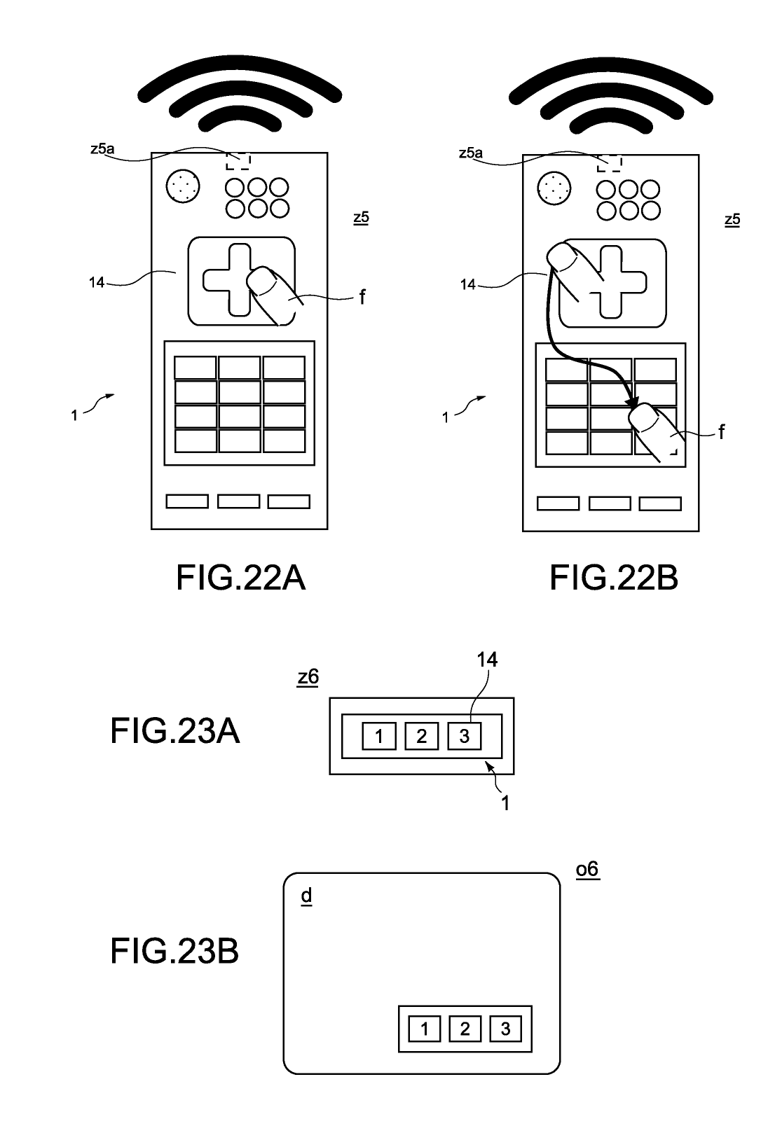

FIGS. 22A and 22B are schematic diagrams each showing the configuration of a remote controller z5 serving as the input device 1 according to this embodiment. The remote controller z5 includes a transmitting unit z5a. The remote controller z5 is configured as a part of a television set, a game machine, or a DVD (Digital Versatile Disk) player that serves as the electronic apparatus z (see FIG. 3), for example. Here, a television set will be described as an example. A television set includes the processing device p (see FIG. 3) and a display device as the output device (see FIG. 3). Characters or designs are drawn on the input operation unit 14 of the remote controller z5 in a key arrangement similar to that of a remote controller for a commonly-used television set.

A description will be given on FIG. 22A. When a push operation of applying a pressing force to a position corresponding to each key of the input operation unit 14 is made with the finger f, the determination unit c1 of the input device 1 determines that the position of the key is put into the push state, and outputs a determination result to the signal generation unit c2 of the input device 1. Thus, the signal generation unit c2 generates an operation signal for performing an operation (for example, “switching of channels” or “display of TV program listing”) corresponding to a character or design of the key at the position being in the push state, and outputs the operation signal to the processing device p. The processing device p generates a command signal based on the operation signal, and the display device performs display based on the operation signal. In this manner, the input device 1 can be used similarly to a remote controller for a commonly-used television set.

Next, a description will be given on FIG. 22B. When a touch operation of moving on the input operation unit 14 is made with the finger f being in contact with the input operation unit 14, the determination unit c1 of the input device 1 determines that a position corresponding to a movement locus of the finger f is put into the touch state, and outputs a determination result to the signal generation unit c2 of the input device 1. Thus, the signal generation unit c2 generates an operation signal for moving the pointer p displayed on the display device of the television set at a time of a programmed recording or the like based on the movement locus of the finger f, and outputs the operation signal to the processing device p of the television set. The processing device p generates a command signal based on operation signal, and the display device moves the pointer p based on the operation signal. In this manner, the input device 1 has a function capable of intuitively moving a pointer.

(Head-Mounted Display)

A description will be given on an example in which the input device 1 according to this embodiment is applied to a head-mounted display (HMD).

FIGS. 23A to 25B are schematic diagrams showing the input device 1 according to this embodiment and an HMD z6 serving as the electronic apparatus z (see FIG. 3). FIGS. 23A, 24A, and 25A are top views each showing the input device 1 according to this embodiment. FIGS. 23B, 24B, and 25B are diagrams each showing a display image that is displayed on the HMD z6 serving as the electronic apparatus z (see FIG. 3) according to this embodiment. The HMD z6 includes the input device 1 and a display device o6 serving as the output device o (see FIG. 3). The HMD z6 may further include the processing device p (not shown) (see FIG. 3). The controller c of the input device 1 may also serve as the processing device p, or the display device o6 may include the processing device p.

The HMD z6 includes a main body to be mounted onto the head of a user and is configured to provide an image via a display d of the display device o6, which is disposed in front of the eyes. The HMD z6 is a non-see-through HMD, for example, but it may be a see-through or semi-see-through HMD.

For example, as shown in FIGS. 23A and 23B, the input device 1 includes keys in a predetermined arrangement, the keys having numbers on the input operation unit 14, and the capacitive elements 11 are arranged at positions corresponding to the respective keys (not shown). Here, numbers 1 to 3 are given to the respective keys. The input device 1 may be configured to have another casing separately from the main body of the HMD z6. In this case, the input device 1 is connected to the main body of the HMD z6 by a cable or radio waves. Alternatively, the input device 1 may be directly arranged in the main body of the HMD z6.

In particular, in the case where the input device 1 of this embodiment is applied to the non-see-through HMD z6, it is difficult for a user to see his/her hands with which an input operation is made on the input device 1. So, there is a possibility that erroneous operations occur. In the HMD z6 according to this embodiment, an image based on an input operation made on the input device 1 is displayed on a display of the display device o6 so that a user can confirm his/her own input operation even if the user has the difficulty of seeing the hands.

A description will be given on FIGS. 23A and 23B. FIG. 23A shows an initial state in which the finger f of the user is not approaching the input operation unit 14. FIG. 23B shows an initial image on the display d. The input operation unit 14 is schematically drawn on the initial image. In this case, the determination unit c1 of the controller c determines neither the touch state nor the push state, and the initial image shown in FIG. 23B does not change.

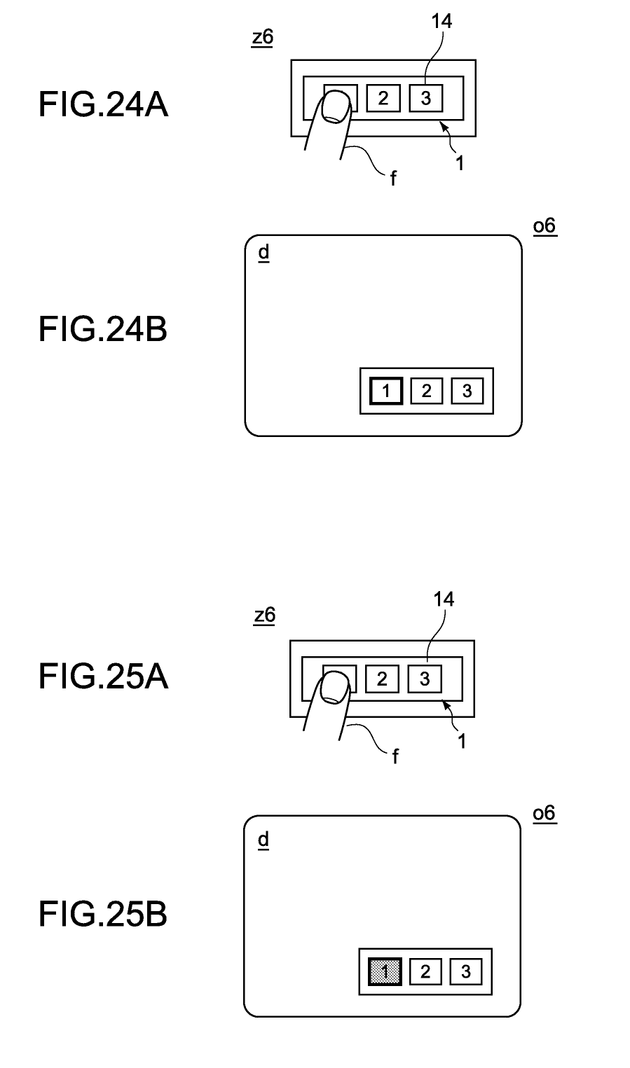

A description will be given on FIGS. 24A and 24B. FIG. 24A shows that the finger f of the user is performing a touch operation on the input operation unit 14 at a position corresponding to a key “1”. At this time, the determination unit c1 of the input device 1 determines that the position of the key is put into the touch state, and outputs a determination result to the signal generation unit c2. The signal generation unit c2 generates an operation signal of information indicating that the position of the key is in the touch state, and outputs the operation signal to the processing device p. The processing device p generates, based on the operation signal, a command signal for controlling an image corresponding to the key “1” displayed on the display image, and the display device o6 displays the image based on the command signal (FIG. 24B). The processing device p displays, on the display d, an image in which the outer edge of the image corresponding to the key “1” is surrounded with a thick line, for example. This image allows the user to recognize that the key “1” is touched.

A description will be given on FIGS. 25A and 25B. FIG. 25A shows that the finger f of the user is performing a push operation on the input operation unit 14 at a position corresponding to the key “1”. At this time, the determination unit c1 of the input device 1 determines that the position of the key is put into the push state, and outputs a determination result to the signal generation unit c2. The signal generation unit c2 generates an operation signal of information indicating that the position of the key is in the push state, and outputs the operation signal to the processing device p. The processing device p generates, based on the operation signal, a command signal for controlling an image corresponding to the key “1” displayed on the display image, and the display device o6 displays the image based on the command signal (FIG. 25B). For example, as shown in FIG. 25B, the processing device p changes the color of the image corresponding to the key “1” and displays on the display d an image in the form different from that in the touch operation. This image allows the user to recognize that the key “1” is pushed.

In addition to the examples shown in FIGS. 24 and 25, the display image is not particularly limited as long as the touch operation and the push operation are clearly distinguished from each other. For example, the display corresponding to the key “1” may blink in touch state, and the color of the display may be changed in the push state. Alternatively, the display form may be changed in the touch or push state.

As described above, with the HMD z6 serving as the electronic apparatus z to which the input device 1 according to the this embodiment is applied, an input operation position and the touch state or the push state can be visually recognized even if the user has the difficulty of seeing the hands with which the input operation is performed. Accordingly, a more precise operation can be performed using the input device 1.

(Operating Element)

In this embodiment, the finger f has been taken as an example of the operating element, but any operating element may be used as long as it has conductivity and elasticity. As another operating element, for example, a stylus pen made of a conductive resin material is used.

### Second Embodiment

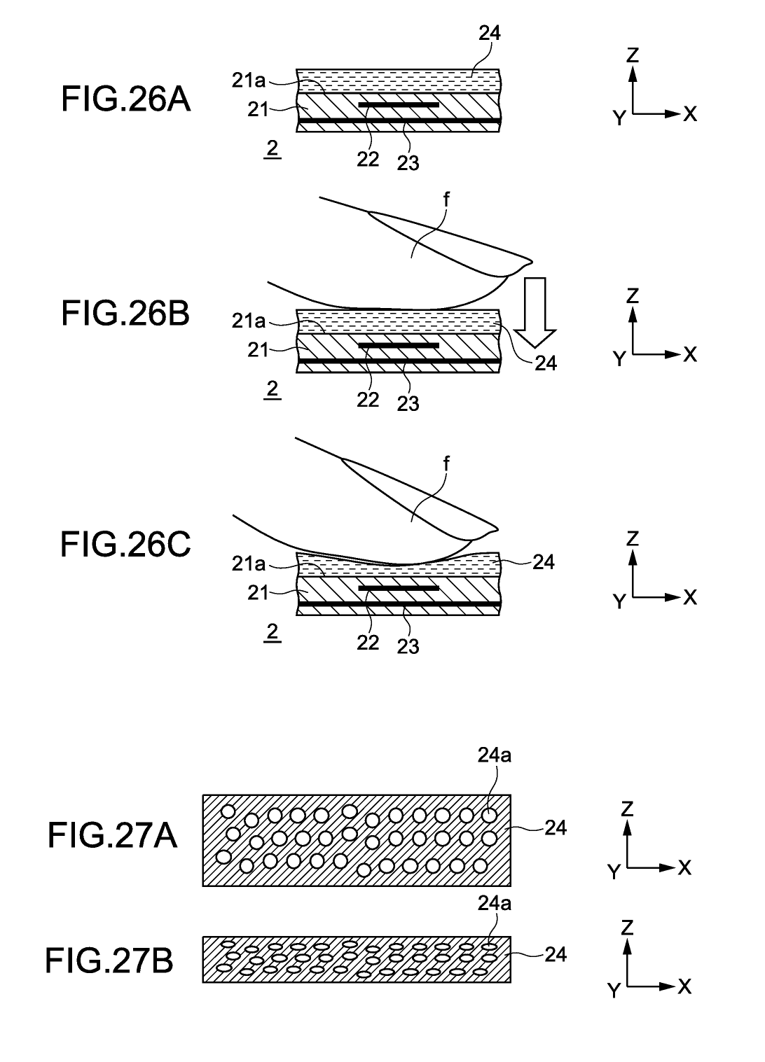

FIGS. 26A to 26C are partial cross-sectional views of an input device 2 according to a second embodiment of the present disclosure. The configuration other than an input operation unit 24 of the input device 2 according to this embodiment is the same as that of the first embodiment, and a description thereof will be omitted as necessary. FIGS. 26A to 26C correspond to FIGS. 2A to 2C according to the first embodiment.

As shown in FIGS. 26A to 26C, a capacitive element 21 has a first surface 21a on which the input operation unit 24 is formed, an X electrode 22, and a Y electrode 23. The X electrode 22 is arranged closer to the first surface 21a than the Y electrode 23 (on upper side in Z-axis direction).

The input operation unit 24 is a sheet with a uniform thickness and is elastically deformed when receiving an operation of the finger f. As a material for forming the input operation unit 24, a material having a relatively high modulus of elasticity is more suitable than one having a low modulus of elasticity in order to suppress deformation in the touch operation. Examples of such a material include a rubber material such as a silicone rubber and foamed materials such as polyurethane and polyethylene. In addition thereto, for example, elastically-deformable materials such as a cloth, a cowhide, and an artificial leather may be used.

FIG. 26B shows a touch state (first state) in which the input operation unit 24 receives a touch operation of the finger f. In the touch state, the finger f does not substantially exert a force on the input operation unit 24. Due to the influence of the finger f as a conductor, the capacitance of the capacitive element 21 in the touch state shown in FIG. 26B is reduced to be lower than that of the capacitive element 21 in a state shown in FIG. 26A in which there is no influence of the finger f.

FIG. 26C shows a push state (second state) in which the input operation unit 24 receives a push operation of the finger f. In the push state shown in FIG. 26C, the finger f is pressed to the input operation unit 24 in the Z-axis direction from the touch state shown in FIG. 26B and then the input operation unit 24 is deformed. Specifically, the finger f in the push state comes closer to the capacitive element 21 than in the touch state. For that reason, the capacitance of the capacitive element 21 in the push state shown in FIG. 26C is further reduced to be lower than that of the capacitive element 21 in the touch state shown in FIG. 26B.

FIGS. 27A and 27B show a touch state and a push state of the input operation unit 24 made of a foamed material, respectively. In the touch state, air holes 24a have a circular cross section and relatively large intervals of dispersion. In the push state, the air holes 24a have a form crushed in the Z-axis direction and relatively small intervals of dispersion.

It should be noted that in this embodiment, the input operation unit 24 has a uniform thickness, but the input operation unit 24 may be provided with a concavo-convex shape as in the case of the input operation unit 14 according to the first embodiment. In this case, in the push state, not only the input operation unit 24 itself but also the finger f are elastically deformed and the finger f gets into concave portions formed in the input operation unit 24.

Further, in this embodiment, the finger has been taken as an example of the operating element, but any operating element may be used as long as it has conductivity. As another operating element, for example, a stylus pen made of a metal material is used.

### Third Embodiment

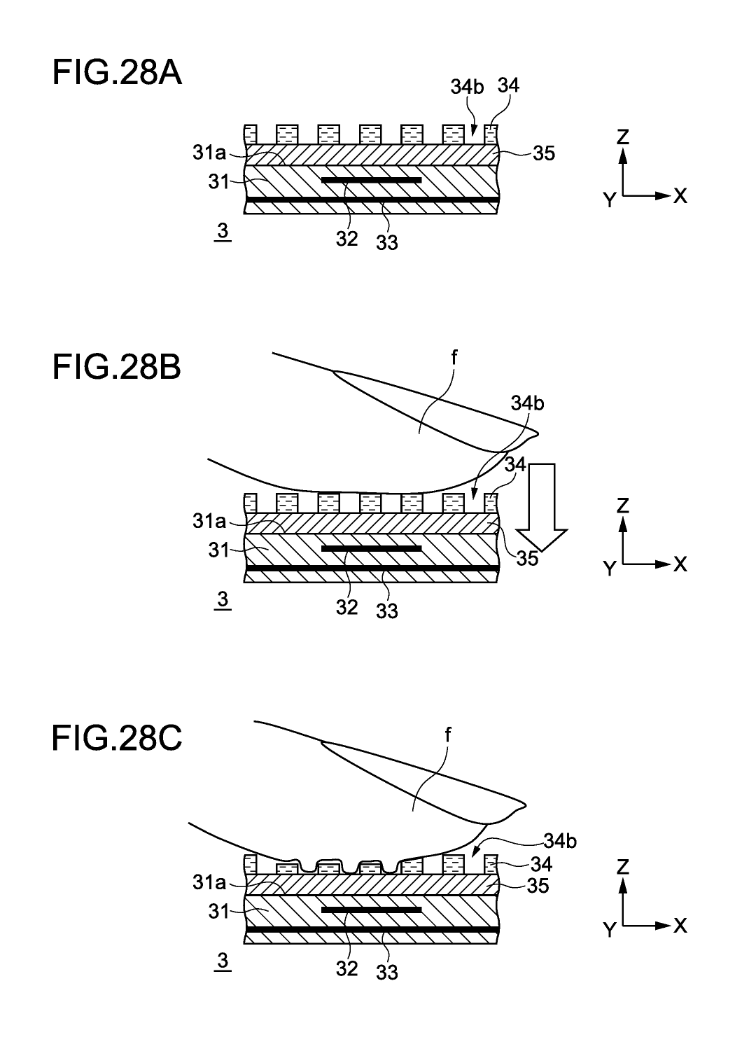

FIGS. 28A to 28C are partial cross-sectional views of an input device 3 according to a third embodiment of the present disclosure. The configuration other than an input operation unit 34 of the input device 3 according to this embodiment is the same as that of the first embodiment, and a description thereof will be omitted as necessary. FIGS. 28A to 28C correspond to FIGS. 2A to 2C according to the first embodiment.

As shown in FIGS. 28A to 28C, a capacitive element 31 has a first surface 31a on which the input operation unit 34 is formed, an X electrode 32, and a Y electrode 33. The X electrode 32 is arranged closer to the first surface 31a than the Y electrode 33 (on upper side in Z-axis direction).

A plate 35 is formed between the capacitive element 31 and the input operation unit 34. In other words, the plate 35 is formed on the first surface 31a of the capacitive element 31, and the input operation unit 34 is formed on the plate 35. The plate 35 is formed of an insulating material that is not easily deformed even when receiving an operation of the finger f. Examples of such a material include polyethylene terephthalate, a silicone resin, polyethylene, polypropylene, acrylic, polycarbonate, and a rubber material. For example, a film, a molded body, or a textile fabric that is made of the materials described above is used for forming the plate 35.

The input operation unit 34 includes protrusions that are arranged at regular intervals on the plate 35 and elastically deformed when receiving an operation of the finger f. The input operation unit 34 is formed of a silicone rubber or the like as in the case of the input operation unit 24 according to the second embodiment.

FIG. 28B shows a touch state (first state) in which the input operation unit 34 receives a touch operation of the finger f. In the touch state, the finger f does not substantially exert a force on the input operation unit 34. Due to the influence of the finger f as a conductor, the capacitance of the capacitive element 31 in the touch state shown in FIG. 28B is reduced to be lower than that of the capacitive element 31 in a state shown in FIG. 28A in which there is no influence of the finger f.

FIG. 28C shows a push state (second state) in which the input operation unit 34 receives a push operation of the finger f. In the push state shown in FIG. 28C, the finger f is pressed to the input operation unit 34 in the Z-axis direction from the touch state shown in FIG. 28B, and the input operation unit 34 is elastically deformed in the Z-axis direction. At the same time, the finger f is deformed to get into concave portions 34b that are formed between the protrusions of the input operation unit 34. Specifically, the finger f in the push state comes closer to the capacitive element 31 than in the touch state. For that reason, the capacitance of the capacitive element 31 in the push state shown in FIG. 28C is further reduced to be lower than that of the capacitive element 31 in the touch state shown in FIG. 28B.

Further, in this embodiment, the finger has been taken as an example of the operating element, but any operating element may be used as long as it has conductivity. As another operating element, for example, a stylus pen made of a metal material is used.

### Fourth Embodiment

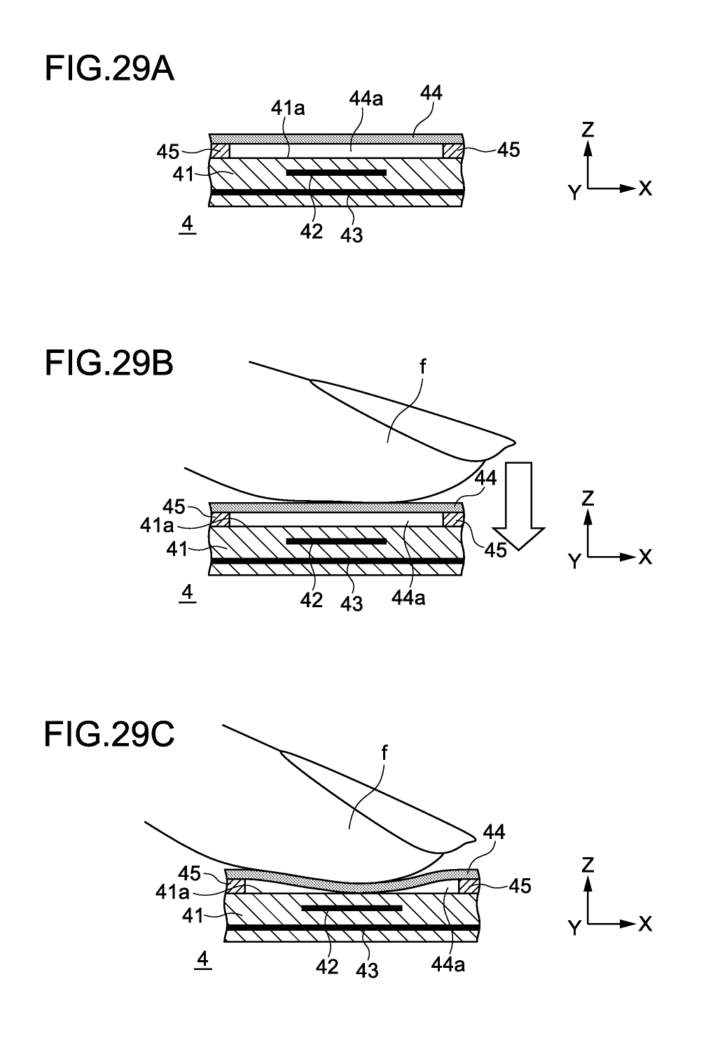

FIGS. 29A to 29C are partial cross-sectional views of an input device 4 according to a fourth embodiment of the present disclosure. The configuration other than an input operation unit 44 of the input device 4 according to this embodiment is the same as that of the first embodiment, and a description thereof will be omitted as necessary. FIGS. 29A to 29C correspond to FIGS. 2A to 2C according to the first embodiment.

As shown in FIGS. 29A to 29C, a capacitive element 41 has a first surface 41a on which the input operation unit 44 is formed, an X electrode 42, and a Y electrode 43. The X electrode 42 is arranged closer to the first surface 41a than the Y electrode 43 (on upper side in Z-axis direction).

A support portion 45 is provided on the first surface 41a of the capacitive element 41 so as to surround a position at which the X electrode 42 and the Y electrode 43 cross. The support portion 45 is formed of an insulating material that is not easily deformed even when receiving an operation of the finger f. Examples of such a material include polyethylene terephthalate, a silicone resin, polyethylene, polypropylene, acrylic, polycarbonate, and a rubber material. For example, a film, a molded body, or a textile fabric that is made of the materials described above is used for forming the support portion 45.

The input operation unit 44 is a sheet that has a uniform thickness and is elastically deformed when receiving an operation of the finger f. The input operation unit 44 is supported by the support portion 45. Therefore, a space 44a is formed between the input operation unit 44 and the capacitive element 41. The sheet, i.e., the input operation unit 44 is formed of a silicone rubber or the like as in the case of the input operation unit 24 according to the second embodiment.

The support portion 45 is for forming the space 44a between the input operation unit 44 and the capacitive element 41. Therefore, the support portion 45 only needs to be configured such that the space 44a may be formed between the input operation unit 44 and the capacitive element 41. For example, the support portion 45 has a configuration as a wall member that surrounds the position at which the X electrode 42 and the Y electrode 43 cross, or a configuration as columnar members that support several spots located around the position at which the X electrode 42 and the Y electrode 43 cross.

FIG. 29B shows a touch state (first state) in which the input operation unit 44 receives a touch operation of the finger f. In the touch state, the finger f does not substantially exert a force on the sheet of the operation unit 44. Due to the influence of the finger f as a conductor, the capacitance of the capacitive element 41 in the touch state shown in FIG. 29B is reduced to be lower than that of the capacitive element 41 in a state shown in FIG. 29A in which there is no influence of the finger f.

FIG. 29C shows a push state (second state) in which the input operation unit 44 receives a push operation of the finger f. In the push state shown in FIG. 29C, the finger f is pressed to the input operation unit 44 in the Z-axis direction from the touch state shown in FIG. 29B, and then a part surrounded by the support portion 45 in the input operation unit 44 is bent downward in the Z-axis direction and gets into the space 44a. Specifically, the finger f in the push state comes closer to the capacitive element 41 than in the touch state. For that reason, the capacitance of the capacitive element 41 in the push state shown in FIG. 29C is further reduced to be lower than that of the capacitive element 41 in the touch state shown in FIG. 29B.

It should be noted that in this embodiment, the input operation unit 44 has a uniform thickness, but the input operation unit 44 may be provided with a concavo-convex shape as in the case of the input operation unit 14 according to the first embodiment. In this case, the input operation unit 44 itself is bent in the push state, and the finger f is also elastically deformed to get into the concave portion formed in the input operation unit 44.

Further, in this embodiment, the finger has been taken as an example of the operating element, but any operating element may be used as long as it has conductivity. As another operating element, for example, a stylus pen made of a metal material is used.

### Fifth Embodiment

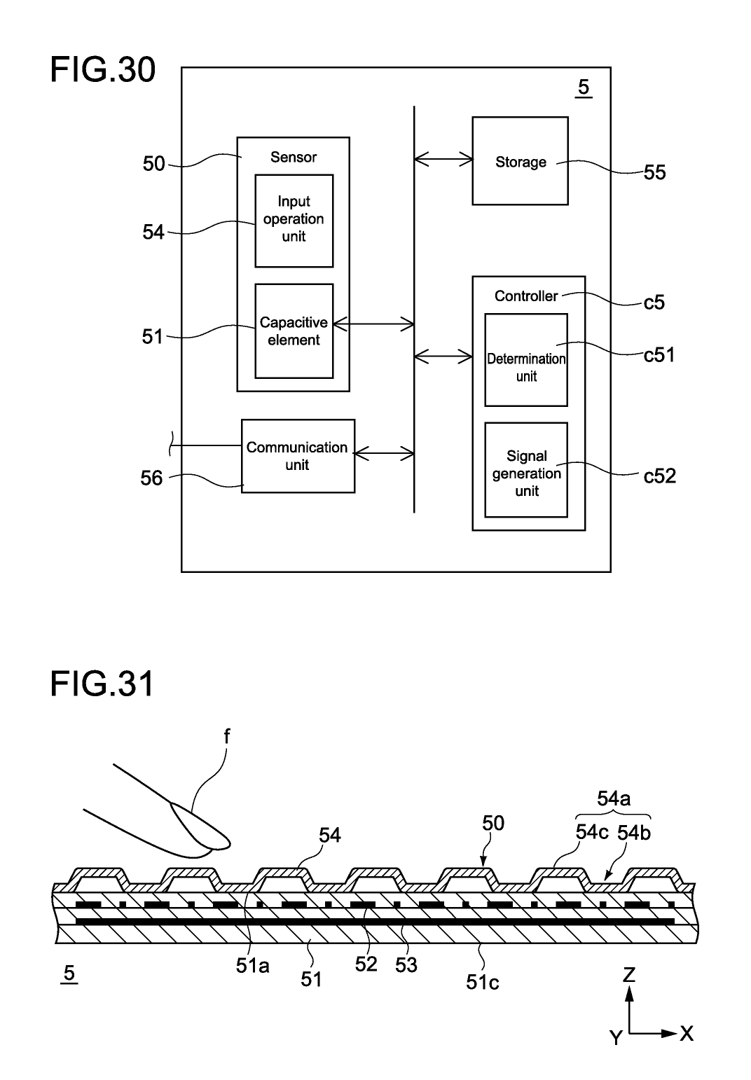

FIGS. 30 to 42 are diagrams showing the configuration of an input device 5 according to a fifth embodiment of the present disclosure. In this embodiment, a description of portions similar to those of the above-mentioned first embodiment will be omitted as necessary.

In general, the schematic configuration of the input device 5 according to this embodiment is similar to that of the above-mentioned input device 1 according to the first embodiment, which is applied to the personal computer. Characters or designs are drawn on the upper surface of the input device 5 in a key arrangement similar to that of a keyboard for a commonly-used personal computer (see FIG. 13). The input device 5 may be used as an input device for a personal computer or as an input device configured to be capable of communicating with a tablet terminal, for example.

The input device 5 is different from the input device 1 according to the first embodiment mainly in that the detection sensitivity of a capacitive element with respect to the approach of an operating element (finger) is adjustable for each key or each capacitive element included in a key. Specifically, the “weight” of a key in the push operation is adjustable for each key or each region of a capacitive element included in a key. It should be noted that in this embodiment, “the detection sensitivity of a capacitive element with respect to the approach of a finger” is assumed to indicate the amount of capacitance change from the initial capacitance of a capacitive element 51 when a finger approaches a first surface 51a of the capacitive element 51 of each sensor 50 by a predetermined distance.

FIG. 30 is a block diagram showing the configuration of the input device 5 according to this embodiment. The input device 5 includes a plurality of sensors 50, a controller c5, a storage 55, and a communication unit 56. As described later, the plurality of sensors 50 are used in the same manner as keys of a personal computer by receiving a push operation and used in the same manner as a trackpad or the like used for selecting a GUI (Graphical User Interface) by receiving a touch operation.

The sensors 50 correspond to respective keys of a keyboard for a commonly-used personal computer. For example, the sensors 50 are arranged on the X-Y plane in a key arrangement similar to that of a keyboard of a commonly-used personal computer (see FIG. 13). Each of the sensors 50 has a predetermined size and shape based on its arrangement or a function assigned thereto.

Each of the sensors 50 includes the capacitive element 51 and an input operation unit 54 and constitutes a capacitive sensor device in a mutual capacitance system. The capacitive element 51 corresponds to the capacitive element 11 according to the first embodiment, and its capacitance is changed by the approach of the finger associated with a touch operation and a push operation that is made with the finger on the input operation unit 54. The input operation unit 54 corresponds to the input operation unit 14 according to the first embodiment.

The controller c5 corresponds to the controller c according to the first embodiment and includes a determination unit c51 and a signal generation unit c52. The determination unit c51 determines, based on the amount of capacitance change of the capacitive element 51 from a reference capacitance, a touch state in which the finger f comes into contact with a second surface 54a of the input operation unit 54 and a change to a push state in which the finger f pushes the second surface 54a for each of the sensors 50. The signal generation unit c52 generates a different operation signal between the touch state and the push state based on the determination of the determination unit c51.

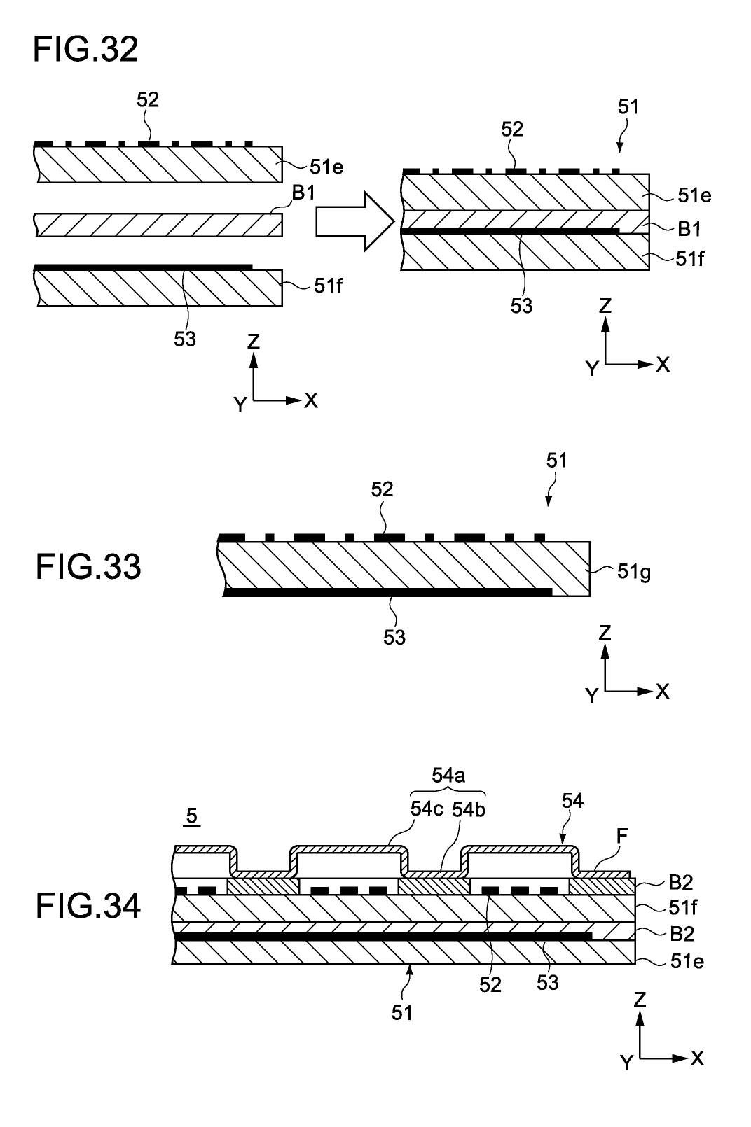

FIG. 31 is a partial cross-sectional view of the input device 5. Each of the sensors 50 includes the capacitive element 51 and the input operation unit 54. The capacitive element 51 has the first surface 51a on which the input operation unit 54 is arranged, a third surface 51c, an X electrode (first electrode) 52, and a Y electrode (second electrode) 53. The third surface 51c is opposed to the first surface 51a in the Z-axis direction. The X electrode 52 is arranged closer to the first surface 51a (on upper side in Z-axis direction), and the Y electrode 53 is arranged closer to the third surface 51c (on lower side in Z-axis direction) to be opposed to the X electrode 52 in the Z-axis direction.

As in the first embodiment, the capacitive element 51 typically has a laminated structure of a plurality of base materials including a substrate on which the X electrodes 52 are formed and a substrate on which the Y electrodes 53 are formed. Examples of the base materials include plastic materials made of PET described in the first embodiment, PC, PMMA (polymethylmethacrylate), and PI. A glass epoxy substrate and the like may also be used. Further, a commonly-used generation method for an electrical circuit may be adopted as necessary for a method of forming the X electrodes 52 and the Y electrodes 53. For example, a method of printing a conductive ink such as a silver paste on a substrate by screen printing, gravure offset printing, or the like, a method of forming a pattern by etching copper foil, a method of forming a pattern by etching a metal film formed by sputtering or vapor deposition, and the like may be adopted.

FIGS. 32 and 33 are schematic cross-sectional views showing a manufacturing example of the capacitive element 51. As shown in FIG. 32, the capacitive element 51 may be obtained by bonding a first substrate 51e having the X electrodes 52 formed thereon and a second substrate 51f having the Y electrodes 53 formed thereon via an adhesive layer B 1. As the adhesive layer B 1, for example, a pressure-sensitive tape, an adhesive agent, or the like may be used. Further, as shown in FIG. 33, the X electrodes 52 and the Y electrodes 53 may be formed on both surfaces of a base material 51g.

With reference to FIG. 31, the input operation unit 54 is arranged on the first surface 51a and has the second surface 54a that receives an operation of the finger f. The second surface 54a includes one convex portion 54c and concave portions 54b. The convex portion 54c is formed for each input operation unit 54. The concave portions 54b are formed in boundary portions with other adjacent input operation units 54 and surround the circumference of the convex portion 54c. Specifically, unlike the first embodiment, the concave portions 54b according to this embodiment are configured to partition the convex portion 54c corresponding to the shape of each key. The convex portion 54c is configured to have the same size and shape as those of each key of a commonly-used keyboard, such as a rectangular column shape or a shape of a truncated square pyramid.

It should be noted that fine concave portions may further be formed on a top surface of the convex portion 54c as a difference in level formed in the Z-axis direction toward the capacitive element 51 (see FIGS. 2A to 2C). In this case, each of the concave portions may be configured to have the shape of an embossed character corresponding to each key as shown in FIG. 5H.

FIG. 34 is a schematic cross-sectional view showing a manufacturing example of the input operation unit 54. As shown in FIG. 34, the input operation unit 54 includes a film F having a concavo-convex structure and is laminated on the capacitive element 51 via an adhesive layer B2. As such a film F, elastic insulating materials including a film made of a commonly-used resin material such as a PET film, a silicone resin, a rubber material can be adopted. With this configuration, the second surface 54a itself that receives a push operation of the finger f is pressed in the Z-axis direction so that the finger f approaches the capacitive element 51 and the capacitive element 51 determines a push state. Further, as the adhesive layer B2, an adhesive agent may be used, for example.

Further, the configuration and the material of the input operation unit 54 are not limited to those described above as long as the finger f can approach the capacitive element 51 when performing a push operation as a press. For example, in the case where the convex portion 54c further includes concave portions on the top surface thereof, the input operation unit 54 may be formed of a resin material that is not easily deformed by the finger f, such as polyethylene terephthalate, polyethylene, and polypropylene. Thus, the finger f is deformed to get into the concave portions of the convex portion 54c so that a push state is determined.

In this embodiment, the plurality of sensors 50 include a plurality of sensors 50, each of which includes a different number of capacitive elements 51. Specifically, each of the sensors 50 includes a predetermined number of capacitive elements 51. Thus, the initial capacitance is adjusted for each of the sensors 50 so that the detection sensitivity is adjusted.

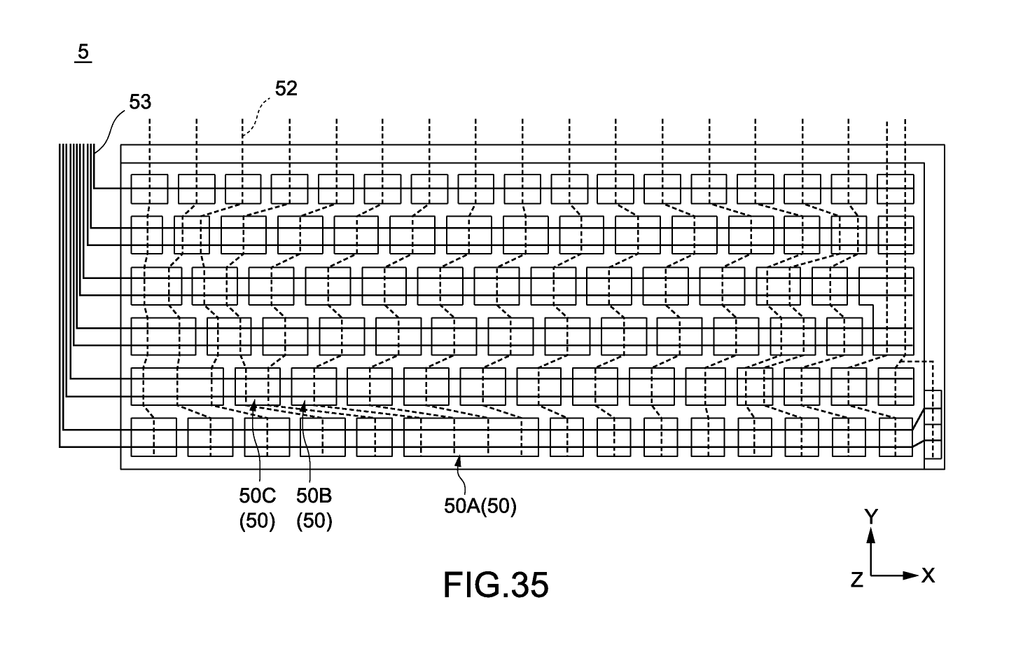

FIG. 35 is a plan view of the input device 5 viewed in the Z-axis direction, and particularly showing a wiring pattern of the X electrodes 52 and Y electrodes 53 of the capacitive elements 51. The X electrodes 52 and the Y electrodes 53 are opposed to each other in the Z-axis direction and formed in a so-called cross-matrix as in the first embodiment. The X electrodes 52 include n columns of the X electrodes 52 extending over the entire range in the Y-axis direction. The Y electrodes 53 include m rows of the Y electrodes 53 extending over the entire range in the X-axis direction. Further, the capacitive elements 51 are formed at the positions at which the X electrodes 52 and the Y electrodes 53 cross each other. As shown in FIG. 35, the X electrodes 52 and the Y electrodes 53 are disposed at irregular pitches in accordance with the arrangement of the sensors 50 and the number of capacitive elements 51 included in the sensors 50.

Here, a specific example of the arrangement of the capacitive elements 51 in each sensor 50 will be described. For example, a sensor 50A corresponds to a so-called “space key”, and eight capacitive elements 51 correspond thereto. Meanwhile, a sensor 50B smaller than the sensor 50A corresponds to a so-called character “S”, and two capacitive elements 51 correspond thereto. In this manner, in this embodiment, each of the sensors 50 does not have the same number of capacitive elements 51 but has the number of capacitive elements 51, which conforms to the size of the sensor 50. Thus, the density of the capacitive elements 51 for determining the touch operation and the push operation is ensured, and even a touch operation in a circumferential portion of the sensor 50A can be precisely detected, for example.

Meanwhile, a sensor 50C corresponds to a so-called character “A”, and four capacitive elements 51 correspond thereto though having substantially the same size as the sensor 50B. Since the sensor 50C is located at a circumferential portion of the input device 5 as compared to the sensor 50B, a user performs an input operation on the sensor 50C with a pinky finger frequently. Since the pinky finger has a smaller ground contact area and applies a smaller force than other fingers, a push operation is hard to determine if the sensor 50C has the detection sensitivity at a similar level to the sensor 50B. Thus, the density of the capacitive elements 51 in the sensor 50C is increased more than that of the sensor 50B, so that the detection sensitivity of the sensor 50C in which a push operation is hard to detect can be increased. Therefore, an evaluation value of the sensor 50C reaches the second threshold value even when the sensor 50C is pressed by a smaller pressing force than the sensor 50B, thus determining a push state. In this manner, the adjustment of the number and size of capacitive elements 51 assigned to each sensor 50 leads to the adjustment of a so-called “key weight”.

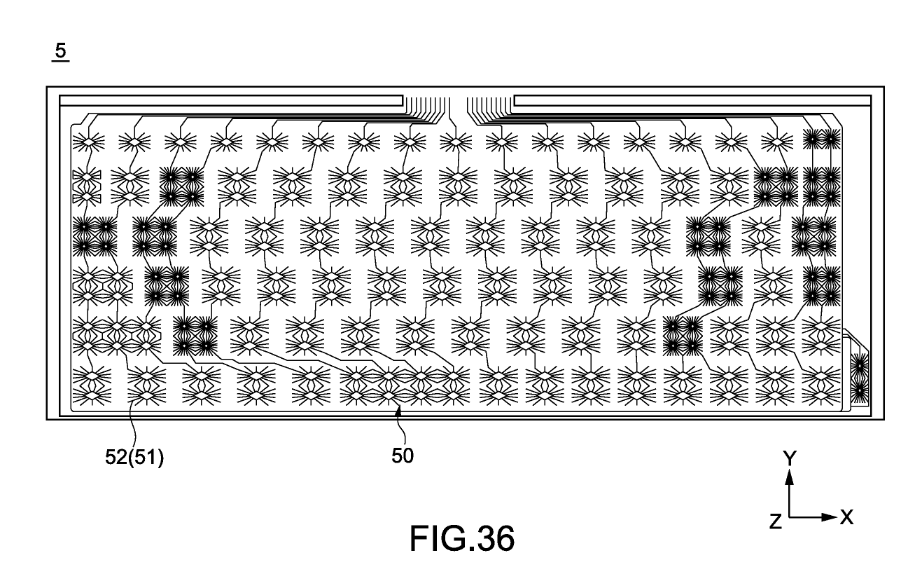

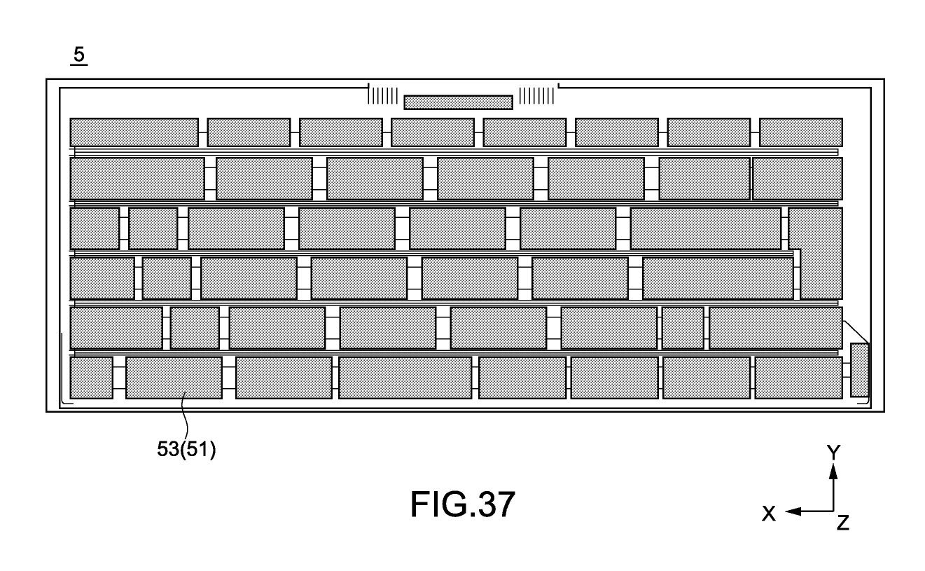

FIG. 36 is a plan view showing the configuration of the X electrodes 52 viewed in the Z-axis direction. FIG. 37 is a plan view showing the configuration of the Y electrodes 53 viewed in the Z-axis direction. In this embodiment, the X electrodes 52 include aggregates of linear electrodes, and the Y electrodes 53 include planar electrodes. Specifically, the X electrodes 52 include aggregates of linear electrodes radially extending from the center of the respective capacitive elements 51, and the Y electrodes 53 include planar electrodes shared by a plurality of sensors 50 adjacent to each other in the X-axis direction.

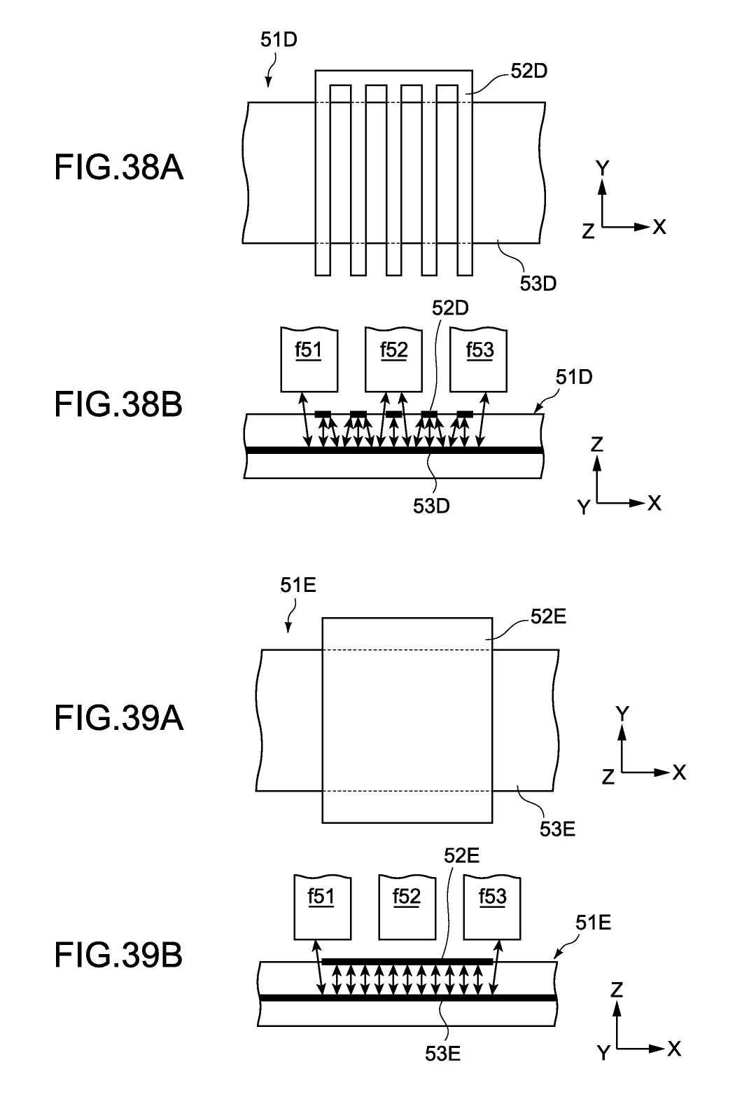

FIGS. 38A to 39B are diagrams for describing the action of the X electrodes 52 and Y electrode 53 configured as described above. FIGS. 38A and 38B show the configuration of a capacitive element 51D including a linear X electrode 52D and a planar Y electrode 53D according to this embodiment. FIGS. 39A and 39B show the configuration of a capacitive element 51E including a planar X electrode 52E and a planar Y electrode 53E according to the related art. FIGS. 38A and 39A are plan views each showing the capacitive element 51 including the X electrode and the Y electrode. FIGS. 38B and 39B are cross-sectional views corresponding to FIGS. 39A and 39B, respectively, viewed in the Y-axis direction. For illustrative purposes, conductors f51, f52, and f53 serving as operating elements approaching the capacitive elements 51D and 51E are shown. Further, arrows in the figures schematically show states of capacitive coupling between the electrodes and between the electrodes and the conductors f51, f52, and f53.

In principle, in a capacitive element in a capacitance system, the amount of capacitance change due to the capacitive coupling between an electrode and an operating element (conductor) is detected, and therefore the detection sensitivity of a capacitive element having a larger electrode area can be increased. In a capacitive element in a mutual capacitance system, mutual capacitive coupling occurs among the operating element, the X electrodes, and the Y electrodes, and a change in capacitance between the X electrodes and the Y electrodes based on the mutual capacitive coupling is detected.

Therefore, as shown in FIGS. 39A and 39B, in the case where the X electrode 52E on the operation side is configured to be planar, the conductor f52 that approaches a region where the X electrode 52E and the Y electrode 53E are opposed to each other is not subjected to capacitive coupling with the Y electrode 53E due to the presence of the X electrode 52E, and therefore a capacitance between the X electrode 52E and the Y electrode 53E does not change. Thus, a region where a capacitance between the X electrode 52E and the Y electrode 53E is hard to change even by the approach of the operating element (hereinafter, referred to as reduced-sensitivity region) is formed on the capacitive element 51E. Specifically, in order to increase the sensitivity of the capacitive element in the mutual capacitance system, it is necessary to increase an electrode area and also suppress the formation of the reduced-sensitivity region.

Meanwhile, as shown in FIGS. 38A and 38B, in the case where the X electrode 52D on the operation side is configured to be linear, a region where the X electrode 52D and the Y electrode 53D are opposed to each other has a smaller area, which allows capacitive coupling to occur between the Y electrode 53D and all the conductors f51 to f53. Therefore, the X electrode 52D linearly configured can suppress the generation of the reduced-sensitivity region in the capacitive element 51D. Further, an increase of the density of the linear electrode allows an increase of the electrode area, which leads to a further increase of the detection sensitivity with respect to the approach of the operating element.

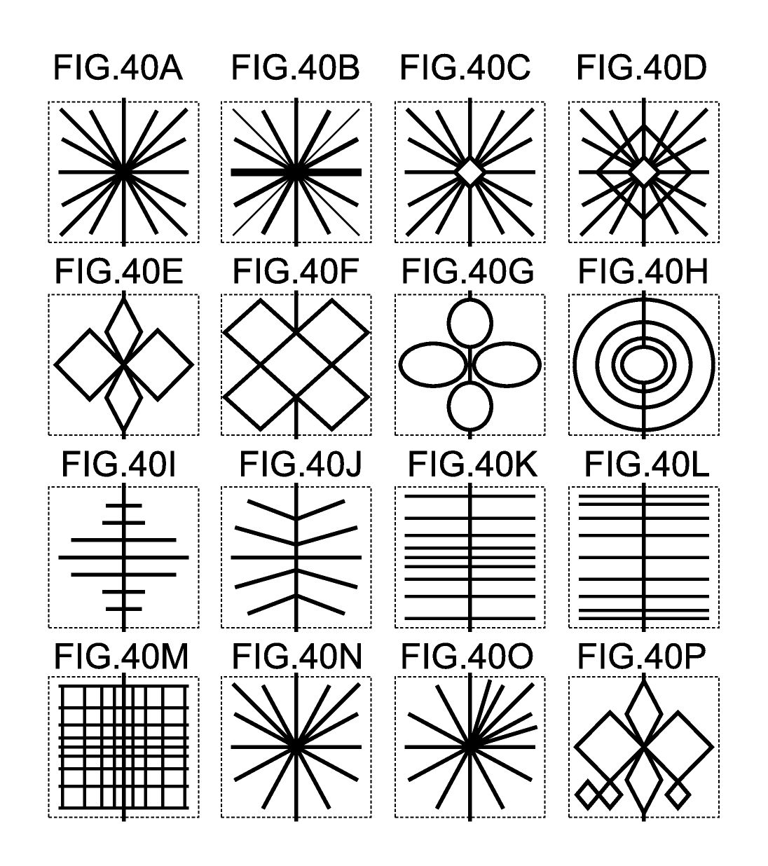

FIGS. 40A to 40P are diagrams each showing a modified example of the X electrode 52 in the capacitive element 51. FIG. 40A shows an example in which a plurality of linear electrodes are radially formed from the center of the capacitive element 51. In this example, the electrode density is different between the center of the capacitive element 51 and a circumferential portion thereof, and the amount of capacitance change due to the approach of a finger is larger in the center than in the circumferential portion. FIG. 40B shows an example in which one of the plurality of linear electrodes radially formed in the example of FIG. 40A is thicker than the other linear electrodes. Thus, the amount of capacitance change on the thick linear electrode is increased more than on the other linear electrodes. Further, FIGS. 40C and 40D each show an example in which an annular linear electrode is arranged at substantially the center of the capacitive element 51 and linear electrodes are radially formed from the center. Thus, the concentration of the linear electrodes at the center is suppressed and the generation of a reduced-sensitivity region is prevented.

FIGS. 40E to 40H each show an example in which a plurality of linear electrodes formed into an annular or rectangular annular shape are combined to form an aggregate. With this configuration, the electrode density is adjustable and the generation of a reduced-sensitivity region is suppressed. Further, FIGS. 40I to 40L each show an example in which a plurality of linear electrodes arranged in the Y-axis direction are combined to form an aggregate. The adjustment of the shape, length, pitch, or the like of the linear electrodes provides a desired electrode density.

In addition, FIGS. 40M to 40P each show an example in which linear electrodes are arranged asymmetrically in the X-axis direction or the Y-axis direction. The X electrode 52 is formed such that the electrode density is asymmetric, and thus the detection sensitivity in the capacitive element 51 is adjusted for each region. Therefore, the detection sensitivity in the sensor 50 is finely adjusted. For example, the sensor 50 arranged in the circumference of the input device 5, such as a sensor 50D shown in FIG. 42, has a region that is more easily subjected to an operation of the finger on the center side thereof than on the circumferential side thereof. Therefore, when the density of the X electrodes 52 arranged on the center side of the input device 5 is increased more than that on the circumferential side, the sensitivity of the sensors 50 on the center side of the input device 5 can be selectively increased.

In this manner, the formation of the X electrode 52 as an aggregate of linear electrodes allows the density of the X electrode 52 in the capacitive element 51 to be changed, which makes it possible to adjust the sensitivity of the capacitive element 51 in the first surface 51a.

Meanwhile, in the Y electrode 53, a plurality of planar electrodes, which are arranged common to a plurality of sensors 50 adjacent to each other in the X-axis direction, are successively arranged along the X-axis direction via short linear electrodes. Such a configuration increases an electrode area of the Y electrode 53 to thereby increase the detection sensitivity. Further, such a configuration imparts a so-called shielding effect of suppressing electrical noise coming from a surface opposite to the second surface 54a of the input device 5.

The determination unit c51 of the controller c5 shown in FIG. 30 calculates an operation position of the finger f on the input operation unit 54 based on the amount of capacitance change obtained from each X electrode 52 and each Y electrode 53 as in the case of the first embodiment (see FIG. 11). It should be noted that the X electrodes 52 and the Y electrodes 53 according to this embodiment are arranged at irregular pitches as a whole as shown in FIG. 35. Therefore, an operation position detected from the X electrode 52 and the Y electrode 53 according to this embodiment may be calculated by, for example, correcting the operation position such that a detected position corresponds to an intersecting position of the X electrode 52 and the Y electrode 53. Alternatively, it may be possible to create in advance a table representing a relationship between a key arrangement and an intersecting position of the X electrode 52 and the Y electrode 53 and for the controller c5 to identify a key operated with reference to the table, to calculate an operation position.

The determination unit c51 determines a touch state or a push state by using an evaluation value based on the amounts of capacitance change in the capacitive elements 51 constituted of the X electrodes 52 or the Y electrodes 53 as in the first embodiment. A predetermined first threshold value and a predetermined second threshold value are set for each of the capacitive elements 51 and stored as threshold data in the storage 55.

The storage 55 is constituted of a RAM (Random Access Memory), a ROM (Read Only Memory), other semiconductor memories, and the like, and stores coordinates of the calculated operation position of the finger or the like of a user, programs used for various computations by the determination unit c51, and the like. For example, the ROM is constituted of a non-volatile memory and stores threshold data associated with the first threshold value and the second threshold value, programs causing the determination unit c51 to execute computation processing such as calculation of an operation position, and the like.

The communication unit 56 is configured to be capable of transmitting various operation signals generated by the signal generation unit c52 to a display device (not shown) or the like. The communication in the communication unit 56 may be performed by a cable via a USB (Universal Serial Bus) and the like or radio waves via “Wi-Fi” (registered trademark), “Bluetooth” (registered trademark), and the like.

The signal generation unit c52 generates an operation signal in accordance with the output signal from the determination unit c51. Specifically, the signal generation unit c52 generates a different operation signal between the touch state and the push state and in the case of detecting the push state, generates a unique operation signal for each of the sensors 50 corresponding to the respective keys of the keyboard.

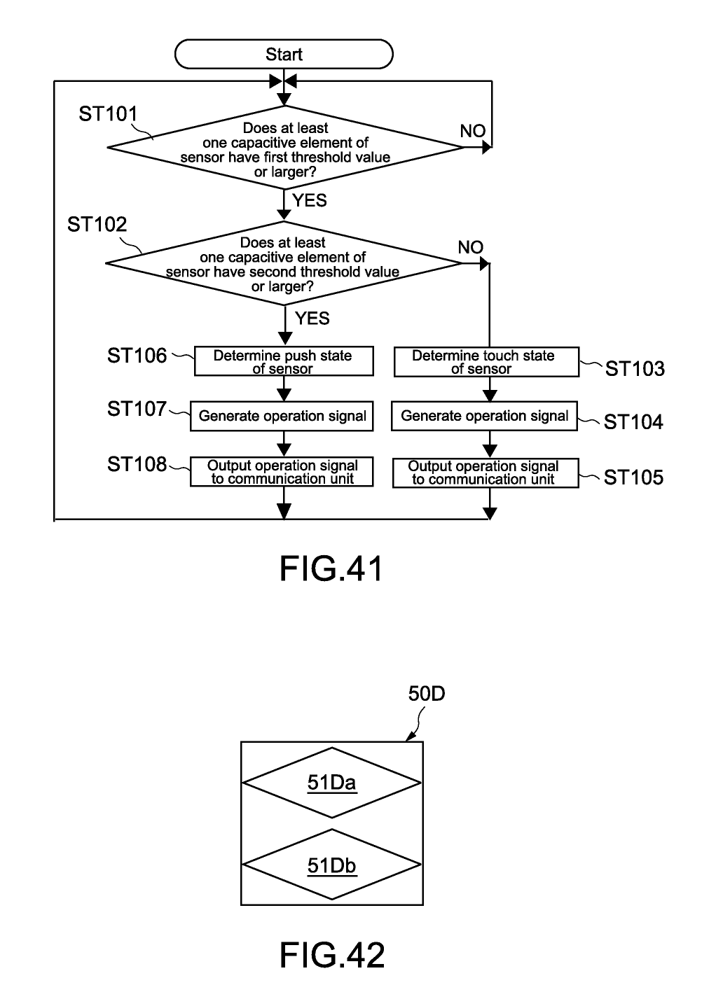

FIG. 41 is a flowchart of an operation example of the input device 5 (controller c5). Further, FIG. 42 is a schematic top view of the sensor 50D including two capacitive elements 51Da and 51Db. Here, a method of determining a touch state or a push state in the case where a certain sensor 50D of the plurality of sensors 50 includes two capacitive elements 51Da and 51Db will be described. It should be noted that the determination unit c51 calculates an operation position of the finger from the above determination and the amounts of capacitance change obtained from the X electrodes 52 and the Y electrodes 53, which is the same operation as that in the first embodiment, and a description thereof will be omitted.

First, the determination unit c51 converts values of capacitance change of the respective sensors 50 into predetermined evaluation values and outputs the evaluation values repeatedly within a predetermined period of time by an output determination circuit of the controller c5. The maximum value of the amounts of capacitance change in the capacitive elements 51, an X combined value, and a Y combined value may be used for the evaluation values as in the first embodiment. Then, the determination unit c51 determines whether the evaluation values of the respective capacitive elements 51 of the sensors 50 are equal to or larger than the first threshold value (Step ST101).

In the case where the evaluation value of at least one of the capacitive element 51Da and the capacitive element 51Db of the sensor 50D is equal to or larger than the first threshold value (Yes in Step ST101), the determination unit c51 determines whether the evaluation value is equal to or larger than the second threshold value (Step ST102). In the case where the evaluation values of both the capacitive elements 51Da and 51Db are smaller than the second threshold value (No in Step ST102), the determination unit c51 determines that the sensor 50D is in the touch state (Step ST103).

Further, the determination unit c51 outputs the result thus obtained to the signal generation unit c52. The signal generation unit c52 to which the result is input generates an operation signal for moving a pointer or the like (Step ST104) (see FIG. 16). Furthermore, the signal generation unit c52 outputs the operation signal to the communication unit 56 (Step ST105).

On the other hand, in the case where the evaluation value of at least one of the capacitive element 51Da and the capacitive element 51Db is equal to or larger than the second threshold value (Yes in Step ST102), the determination unit c51 determines that the detected sensor 50D is in the push state (Step ST106). Further, the determination unit c51 outputs the result thus obtained to the signal generation unit c52. The signal generation unit c52 to which the result is input generates an operation signal unique to the sensor 50D (Step ST107) (see FIG. 15). Furthermore, the signal generation unit c52 outputs the operation signal to the communication unit 56 (Step ST108).

The determination unit c51 continuously repeats a determination as to whether the evaluation value is equal to or larger than the first threshold value based on the output values of capacitance change (Step ST101).

As described above, the input device 5 according to this embodiment can determine the touch state or the push state in a sensor 50 even if the sensor 50 includes a plurality of capacitive elements 51. Therefore, the input device 5 can be used as an input device having functions of a keyboard and a pointing device.

Further, according to the embodiment described above, the number or size of the capacitive elements 51 assigned to each of the sensors 50 is adjusted so that the initial capacitance of the sensors 50 in the input device 5 can be adjusted. Therefore, the detection sensitivity of the sensors 50 can be adjusted based on the arrangement of the sensors 50 in the input device 5, an area size occupied by the sensors 50, the arrangement or use frequency of each sensor 50, and the like.

Furthermore, the formation of the X electrode 52 of the capacitive element 51 as an aggregate of linear electrodes allows the shape of the X electrode 52 in each capacitive elements 51 to be easily changed, which makes it possible to adjust the initial capacitance. Thus, the “weight” of a key in a push operation is adjustable for each key or each region of a key in which a capacitive element is disposed. In addition, it is possible to suppress the generation of a so-called reduced-sensitivity region in which capacitive coupling between the Y electrode 53 and the finger is hindered.

Further, the Y electrode 53 includes planar electrodes, which allows the configuration producing a shielding effect to be provided.

### Sixth Embodiment

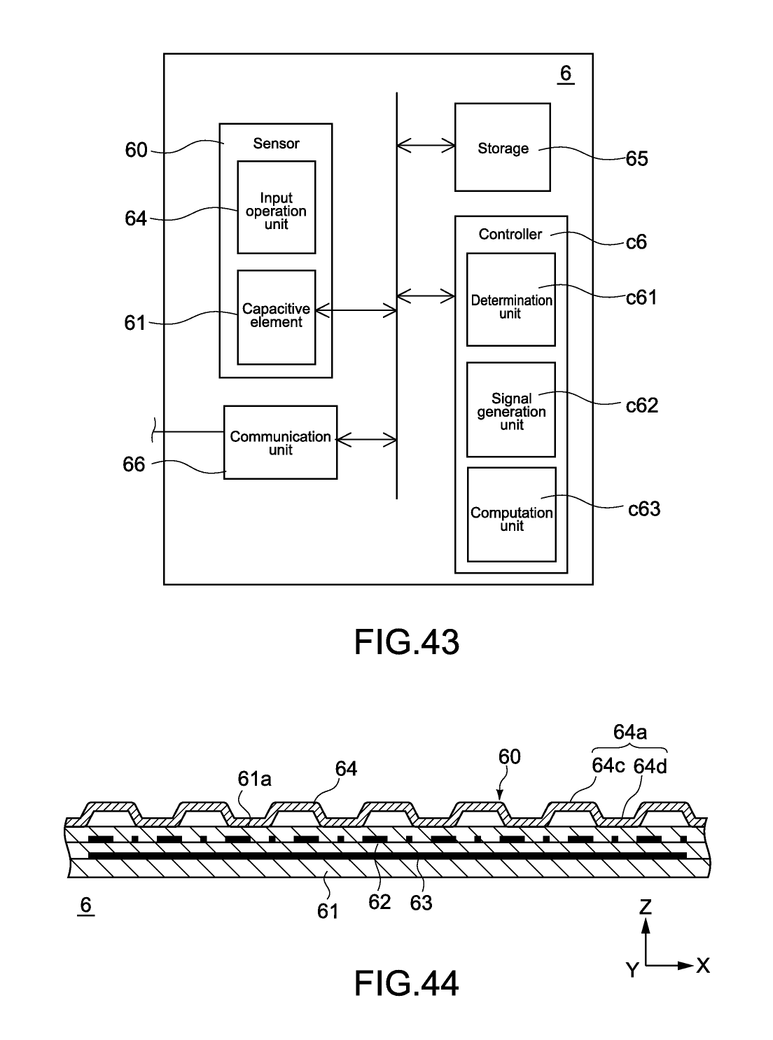

FIGS. 43 to 50B are diagrams for describing an input device 6 according to a sixth embodiment of the present disclosure. In this embodiment, a description of portions similar to those of the above-mentioned first and fifth embodiments will be omitted as necessary.

FIG. 43 is a block diagram showing the configuration of the input device 6 according to this embodiment. The input device 6 includes a plurality of sensors 60, a controller c6, a storage 65, and a communication unit 66, which correspond to the plurality of sensors 50, the controller c5, the storage 55, and the communication unit 56 of the input device 5 according to the fifth embodiment, respectively, and a description thereof will be omitted as necessary.

The controller c6 of the input device 6 includes a determination unit c61 and a signal generation unit c62. The determination unit c61 determines a touch state or a push state by using evaluation values that are based on the amounts of capacitance change in capacitive elements 61 formed by X electrodes 62 or Y electrodes 63. First and second threshold values used in the determination are stored in a ROM of the storage 65 as threshold data and are used for the determination of the first and second threshold values after being loaded into a RAM as necessary.

The controller c6 according to this embodiment further includes a computation unit c63. The computation unit c63 changes a second threshold value based on the detection sensitivity of the capacitive elements 61, and the like, as described later.

FIG. 44 is a schematic cross-sectional view showing the configuration of the sensor 60. The sensor 60 includes a capacitive element 61 and an input operation unit 64 as in the fifth embodiment. The capacitive element 61 has a laminated structure of a plurality of base materials including a substrate on which the X electrodes 62 are formed and a substrate on which the Y electrodes 63 are formed.

The plurality of sensors 60 according to this embodiment include a plurality of sensors 60, each of which includes a different number of capacitive elements 61. In this embodiment, each of the sensors 60 includes one or more of capacitive elements 61, that is, a predetermined number of capacitive elements 61 that correspond to the size (occupied area) of each sensor 60. Thus, the capacitive elements 61 are disposed at a substantially uniform density within an operation region of the input device 6.

Here, the sensors 60 may be different from one another in the sensitivity in capacitance change of the capacitive elements 61 with respect to the finger, depending on an electrode width, a thickness of the base material that forms the capacitive elements 61, a dielectric constant, and the like. So, a second threshold value is set based on the sensitivity in capacitance change of the sensors 60 so that the uniformity in determination of a touch or push state is achieved for each sensor 60.

Hereinafter, an operation example for setting a second threshold value used in the determination of a push state in the input device 6 according to this embodiment will be described. Here, for example, an operation example in the case of setting the initial value of the second threshold value before the shipping of the input device 6 as a product will be described.

First, the determination unit c61 calculates in advance a capacitance (initial capacitance) obtained at this time based on an electrical signal that is output from each capacitive element 61 to which the operating element such as a finger is not coming close. This initial capacitance value may be output to the storage 65 and then stored.

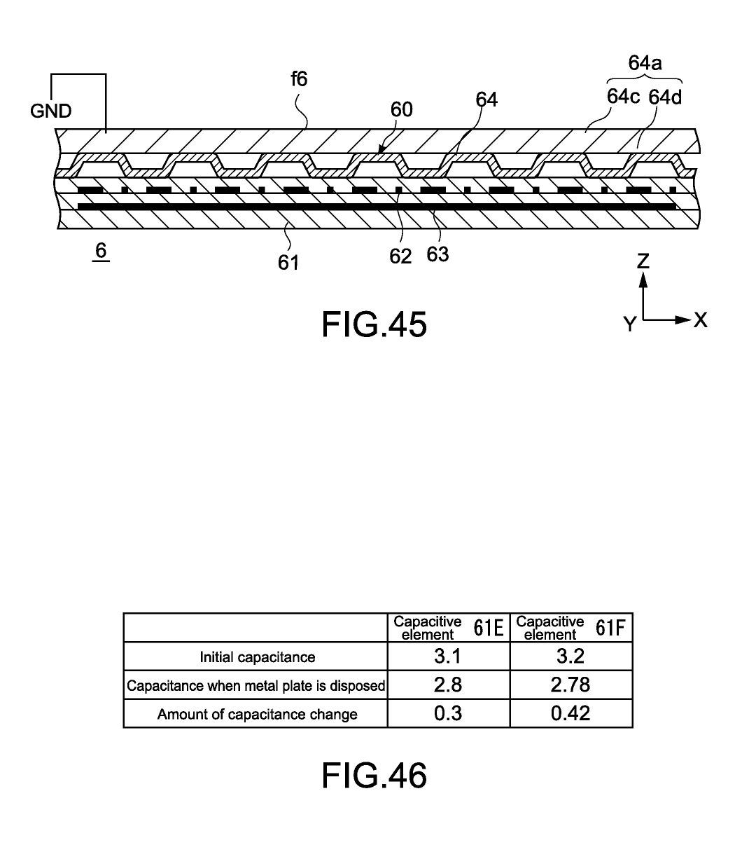

FIG. 45 is a schematic cross-sectional view of sensors 60, showing a state in which a substantially flat metal plate f6 is disposed on a second surface 64a of the input operation unit 64. The metal plate f6 is formed in such a size to cover the input operation units 64 of all the sensors 60 and is grounded as shown in FIG. 45. At this time, the capacitance of each capacitive element 61 is changed by a predetermined amount from the initial capacitance at a time when a conductor such as the metal plate f6 and a finger does not come close thereto. This amount of change is seen as the amount of capacitance change obtained when an operating element such as a finger approaches each capacitive element 61 by a constant distance, and is considered to be the detection sensitivity of each capacitive element 61 with respect to the approach of the finger.

The determination unit c61 calculates the amounts of capacitance change in the respective capacitive elements 61 from differences between the initial capacitances and capacitances obtained when the metal plate f6 is disposed. Those values are output to the storage 65 and stored as data of the amounts of capacitance change in the capacitive elements 61 together with values of the initial capacitances and the like. Further, those values may be output to the communication unit 66 and displayed on a monitor of a display device (not shown) or the like.

FIG. 46 is an example of a table showing the amounts of capacitance change of two capacitive elements 61E and 61F included in the input device 6. Numerical values of the table shown in FIG. 46 are represented in a unit of pF. The unit used for a capacitance is merely an example and may be “fF”, “nF”, or “μF” for example, depending on the range of capacitance detection of an IC (Integrated Circuit) to be used. In FIG. 46, the initial capacitance of the capacitive element 61E is 3.1 pF, and the initial capacitance of the capacitive element 61F is 3.2 pF. When the metal plate f6 is disposed on the second surface 64a of the input operation units 64 corresponding to the capacitive elements 61E and 61F, the capacitance of the capacitive element 61E and that of the capacitive element 61F are changed to 2.8 pF and 2.78 pF, respectively. Differences between the initial capacitances and the capacitances when the metal plate f6 is disposed are 0.3 pF in the capacitive element 61E and 0.42 pF in the capacitive element 61F. Those values correspond to the detection sensitivity with respect to the approach of a finger.

Further, the computation unit c63 can also perform predetermined computation processing on the data of those amounts of capacitance change to set the resultant values thus calculated as evaluation values for the detection sensitivity (hereinafter, referred to as sensitivity evaluation value). For example, in computation processing of multiplying the amount of capacitance change by 100, a sensitivity evaluation value of the capacitive element 61E is 30, and a sensitivity evaluation value of the capacitive element 61F is 42. Thus, the sensitivity evaluation value can be set as an integer, which facilitates the evaluation of the detection sensitivity.

Further, the computation unit c63 compares the magnitude of the sensitivity evaluation values of the capacitive elements 61 so that the magnitude of the detection sensitivity of the respective capacitive elements 61 can be evaluated. In the above example, it is possible to easily evaluate that the sensitivity of the capacitive element 61F is higher than that of the capacitive element 61E.

Further, the computation unit c63 performs predetermined computation processing on those sensitivity evaluation values and calculates a second threshold value of each capacitive element 61. As an example of such computation processing, a constant value β is added or subtracted. For example, assuming that β=5 and β is subtracted from each of the evaluation values, an expression, 30−5=25, is obtained for the capacitive element 61E, and 42−5=37 for the capacitive element 61F. In this manner, calculations are performed, with the result that the second threshold value of the capacitive element 61E is 25 and the second threshold value of the capacitive element 61F is 37.

It should be noted that the first threshold value is also set in the same manner. For example, the computation unit c63 performs predetermined computation processing, which is different from that performed when the second threshold value is set, based on a difference between the initial capacitance calculated by the determination unit c61 and a capacitance at a time when the metal plate is disposed. Thus, a first threshold value corresponding to the detection sensitivity of each capacitive element 61 can be set.

The computation unit c63 stores the calculated first and second threshold values in the storage 65. Thus, the storage 65 can store data on the first and second threshold values of the capacitive elements 61 as “threshold data”.

For example, the value β described above can be made different for each capacitive element 61. Thus, a second threshold value of each capacitive element 61 can be set, and the detection sensitivity with respect to a push operation can be made different for each capacitive element 61.

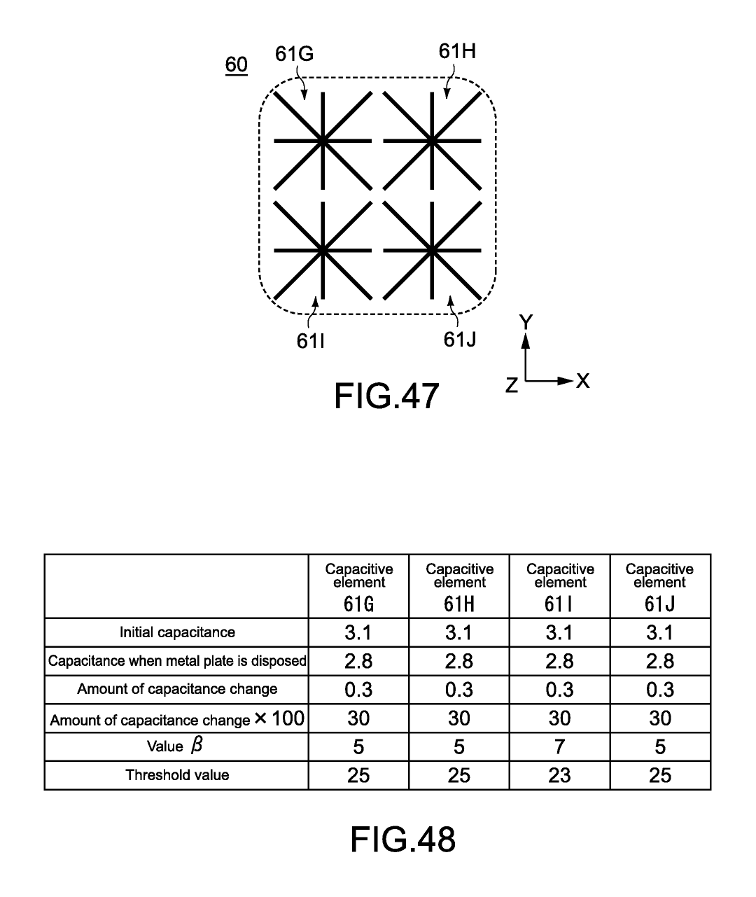

FIGS. 47 and 48 are diagrams showing an example in which a second threshold value is set as in the operation example described above in the case where one sensor 60 includes four capacitive elements 61. FIG. 47 is a schematic plan view showing an arrangement of capacitive elements 61G, 61H, 61I, and 61J in the sensor 60. FIG. 48 is a diagram showing data examples on the setting of threshold values in the respective capacitive elements 61G to 61J.

The capacitive elements 61G to 61J each include X electrodes having substantially the same size and shape and have the same value in an initial capacitance, a capacitance at a time when the metal plate f6 is disposed, and a difference between those capacitances, that is, the amount of capacitance change. So, the value β of the capacitive elements 61G, 61H, and 61J is set to 5, and that of the capacitive element 61I is set to 7 so that the second threshold values of the capacitive elements 61G, 61H, and 61J can be made different from that of the capacitive element 61I.

Thus, of the capacitive elements 61G to 61J, only the second threshold value of the capacitive element 61I is smaller than those of the other capacitive elements 61G, 61H, and 61J. Therefore, in a region of the sensor 60 in which the capacitive element 61I is arranged, a push state caused by a finger having a smaller pressing force or having a smaller ground contact area than in the other regions of the sensor 60 is determined.

In this manner, the input device 6 according to this embodiment can separately set a first and a second threshold values for each sensor 60 or capacitive element 61. Thus, the detection sensitivity of a push state and a touch state can be changed for each sensor 60 or capacitive element 61 in a sensor 60. Therefore, a so-called “key weight” can be changed for each sensor 60 corresponding to each key or for each region of a sensor 60.

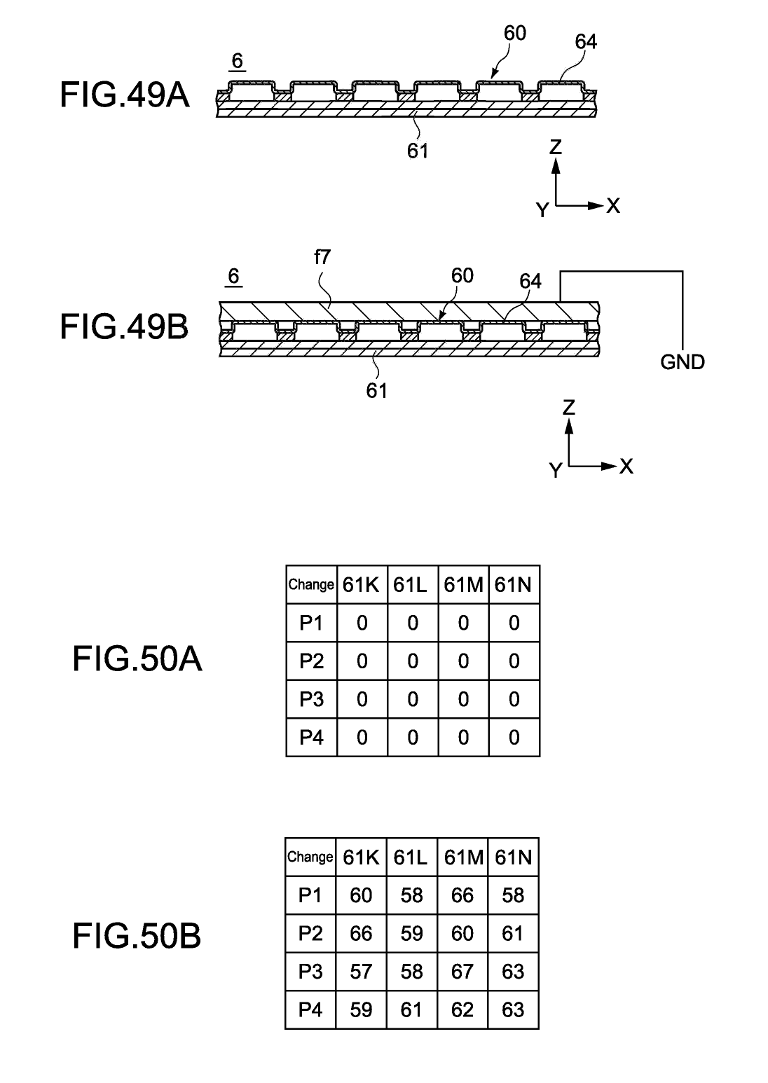

FIGS. 49A to 50B are diagrams for describing an example for setting the threshold data described above. FIGS. 49A and 49B are schematic cross-sectional views of the input device 6. FIGS. 50A and 50B are diagrams each showing a data example of sensitivity evaluation values that are based on the amounts of capacitance change from the initial capacitances of a sensor 60 including capacitive elements 61K, 61L, 61M, and 61N. It should be noted that P1 to P4 of the tables shown in FIGS. 50A and 50B represent trials in which sensitivity evaluation values were acquired as described later.

In this example, a metal plate is repeatedly disposed on the sensor 60 several times (here, four times), and a second threshold value is calculated from an average value of sensitivity evaluation values that are output in respective cases. For example, FIG. 49A shows a form in which a metal plate f7 is not disposed on the sensor 60. In this case, the sensitivity evaluation values of the respective capacitive elements 61K to 61N are zero with reference to FIG. 50A. Subsequently, with use of a predetermined jig or the like, the metal plate f7 is repeatedly disposed on the sensor 60 four times, for example (FIG. 49B). Thus, the sensitivity evaluation values of the respective capacitive elements 61K to 61N are calculated by the determination unit c6 as shown in FIG. 50B. Data of an average value of those above values is stored in the ROM or the like of the storage 65, and with use of the data, a second threshold value is calculated. Accordingly, a threshold value can be set based on more precise data of detection sensitivity.

In this manner, the input device 6 according to this embodiment can change “key weight” by merely changing the parameter setting for the controller c6, unlike a membrane keyboard or the like having a mechanical configuration in related art. Therefore, a key weight can be easily set without changing the configuration of the input device 6.

With this configuration, the input device 6, with which an easy push operation is performed, can be provided to children or elderly people whose finger force is weak, and the customization of the input device 6 can be made in accordance with characteristics of an individual user, such as a left-hander, a right-hander, and the size of a hand or a finger. In this manner, according to this embodiment, a desired operational feeling conforming to characteristics or the like of a user can be achieved by only a change of a parameter setting.

### Seventh Embodiment

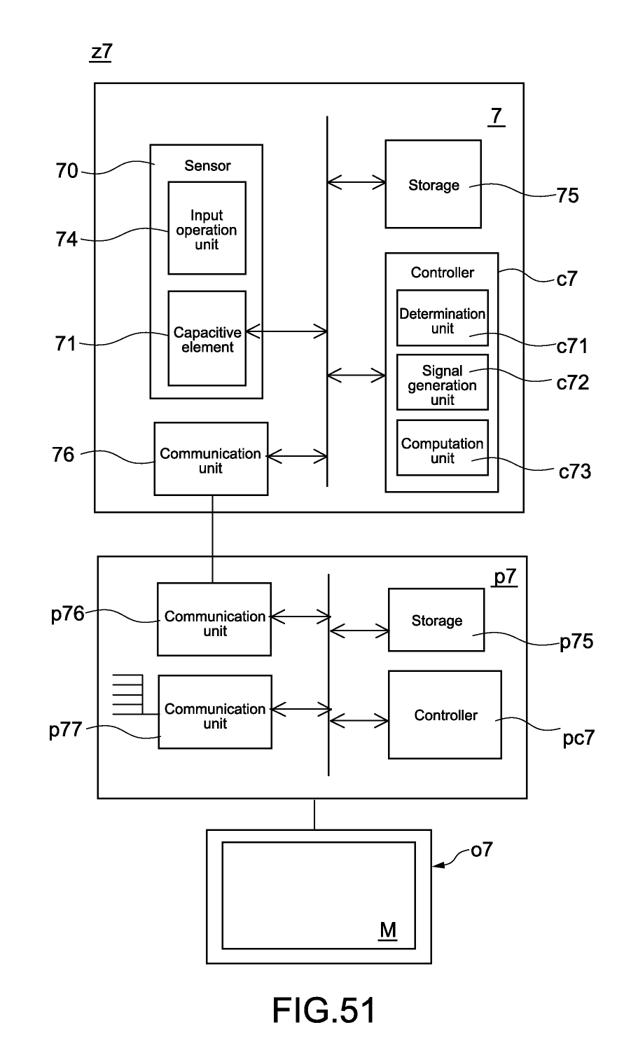

FIGS. 51 to 54 are diagrams for describing an input device 7 (electronic apparatus z7) according to a seventh embodiment of the present disclosure. In this embodiment, a description of portions similar to those of the above-mentioned first and sixth embodiments will be omitted as necessary.

FIG. 51 is a block diagram showing the configuration of an electronic apparatus z7 in an example in which the input device 7 according to this embodiment is applied to a personal computer serving as the electronic apparatus z7. The electronic apparatus z7 includes the input device 7, a processing device p7, and an output device (display device) o7.

The input device 7 includes a plurality of sensors 70, a controller c7, a storage 75, and a communication unit 76, which correspond to the plurality of sensors 60, the controller c6, the storage 65, and the communication unit 66 of the input device 6 according to the sixth embodiment, respectively, and a description thereof will be omitted as necessary.

The controller c7 of the input device 7 includes a determination unit c71, a signal generation unit c72, and a computation unit c73. The determination unit c71 determines a touch state or a push state by using evaluation values that are based on the amounts of capacitance change in capacitive elements 71 formed by X electrodes or Y electrodes. First and second threshold values used in the determination are stored in a ROM of the storage 75 as threshold data. The computation unit c73 changes a second threshold value based on a command or the like from the processing device p7 as described later.

The processing device p7 includes a controller pc7, a storage p75, and communication units p76 and p77.

The communication unit p76 is configured to transmit and receive various operation signals generated by the signal generation unit c72 of the input device 7. For example, in the case of a desktop type electronic apparatus z7, the communication is typically performed using a cable via a USB or the like. It should be noted that in a notebook type, the electronic apparatus z7 may be configured to be free from the communication unit p76 and configured such that the controller pc7 of the processing device p7 also serves as the controller c7 of the input device 7.

On the other hand, the communication unit p77 is connected to a communication network such as the Internet. The communication unit p77 is used for, for example, downloading a predetermined program such as an application to the processing device p7. The transmission and reception of information in the communication unit p77 may be performed by a cable such as a LAN cable or by radio waves as in high-speed data transmission.

The controller pc7 is typically constituted of a CPU. In this embodiment, the controller pc7 executes various functions based on information received from the input device 7 according to a program stored in the storage p75. For example, in the case where a push state is determined for a sensor 70 of the input device 7, which corresponds to a key with the character “A”, an operation signal generated in the signal generation unit c72 is transmitted to the communication unit p76 and then output to the controller pc7. The controller pc7 generates a command signal for displaying the character “A” on the display device o7 based on the operation signal.

Further, the controller pc7 activates utility software for adjusting a sensor sensitivity, which is stored in the storage p75 (hereinafter, referred to as sensitivity adjustment software) and displays a threshold-value inputting image of the software on a monitor M of the display device o7. Further, the controller pc7 generates a command signal for changing the first and second threshold values of threshold data according to an input of the user into the input device 7.

The storage p75 is constituted of a RAM, a ROM, other semiconductor memories, and the like as in the storage 65, and stores a program and the like used for various computations by the controller pc7. For example, the ROM is constituted of a non-volatile memory and stores a setting value or the sensitivity adjustment software for instructing the controller pc7 to change threshold data. Further, those programs stored in advance may be loaded into the RAM temporarily and executed by the controller pc7.

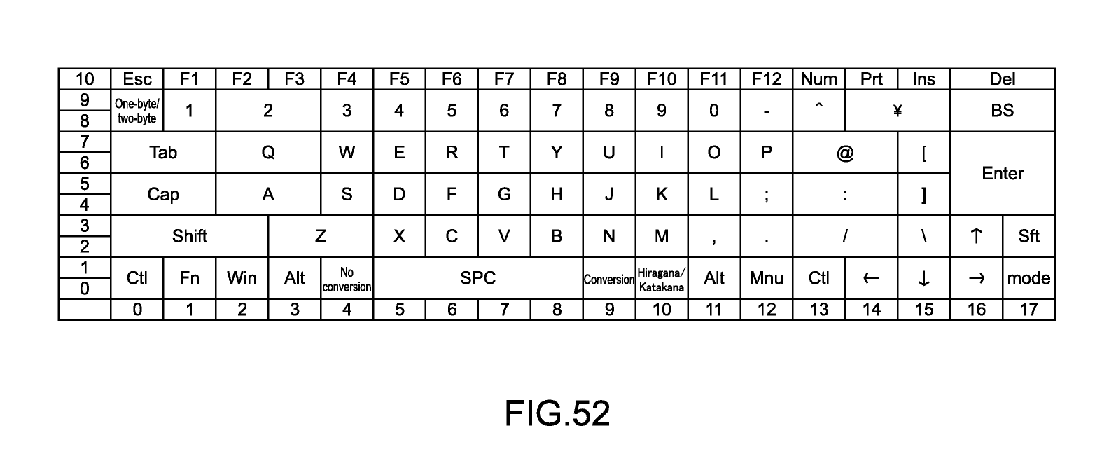

The display device o7 includes the monitor M and displays a predetermined image on the monitor M based on the command signal generated by the controller pc7. For example, the display device o7 to which a command signal for displaying the character “A” is output displays the character “A” on the monitor M based on the command signal (see FIG. 15). Alternatively, it is also possible to display a threshold-value setting image or the like for changing threshold data of each capacitive element 71 (see FIGS. 52 to 54).

Hereinafter, an operation example of the electronic apparatus z7 according to this embodiment will be described. Here, described is an example in which the sensitivity adjustment software is activated by an input operation of the user, and an input operation of changing a second threshold value of each capacitive element 71 is performed.

In response to an input operation of the user or the like, the processing device p7 (controller pc7) first accesses the storage p75 to activate the sensitivity adjustment software. The input operation of the user at this time may be, for example, an operation of selecting an icon indicating the sensor sensitivity adjustment software displayed on the monitor M. Thus, a threshold-value setting image used by the user for changing threshold data is displayed on the monitor M of the display device o7. Specifically, based on the operation of the user, the electronic apparatus z7 switches the mode from an input operation mode to determine the touch and push states described above to a change mode to change a second threshold value.

Next, the electronic apparatus z7 receives inputs on the second threshold values of a part of the plurality of sensors 70 and generates a change command signal based on the thus-input instruction values. The “instruction value” used herein may be a value on a second threshold value already changed or a value on an increment and decrement of the second threshold values before and after the change. Further, the “instruction value” may be a second threshold value itself, a sensitivity evaluation value corresponding to a second threshold value, and the like.

For example, the user selects some cells of the threshold-value setting image, which correspond to a capacitive element 71 that is intended to be changed, and then inputs instruction values to the cells. Thus, the controller pc7 of the electronic apparatus z7 generates a change command signal for changing threshold data based on the instruction values. The change command signal is output to the controller c7 of the input device 7 via the communication unit p76.

Based on the change command signal, the controller c7 of the input device 7 controls the storage 75 to change the threshold data stored in the storage 75. Thus, second threshold values of a part of the plurality of sensors 70 are changed to values different from the second threshold values of the other sensors 70, and the threshold data is changed to have a predetermined value by the input of the user.

Furthermore, the controller pc7 of the processing device p7 generates a command signal for output to the display device o7 based on an operation signal generated due to the input operation of the instruction values. The display device o7 displays a changed threshold-value setting image on the monitor M based on the command signal.

After the threshold data is changed, the display of the threshold-value setting image on the monitor M is ended by the predetermined input operation of the user.

FIGS. 52 to 54 are diagrams showing an example of the threshold-value setting image displayed on the monitor M of the display device o7. In the threshold-value setting image, cells on which predetermined characters or numbers are displayed are arranged as seen in spreadsheet software, for example. The sensors 70 are assigned to the respective cells as shown in FIG. 52. It should be noted that the image shown in FIG. 52 may be displayed on the monitor M as the initial image of the sensitivity adjustment software, or the like, or may not be displayed thereon.

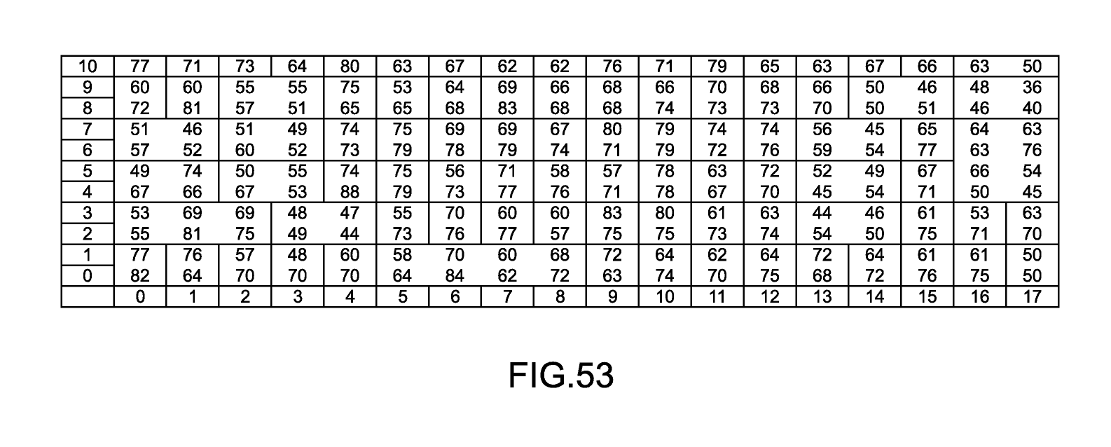

FIG. 53 shows an example of the threshold-value setting image in which second threshold values of capacitive elements 71 included in the sensors 70, which are not yet changed, are displayed at predetermined cells. Those values may be initial values that are set at the shipping (see FIGS. 45 and 49B). Alternatively, those values may be sensitivity evaluation values corresponding to the second threshold values.

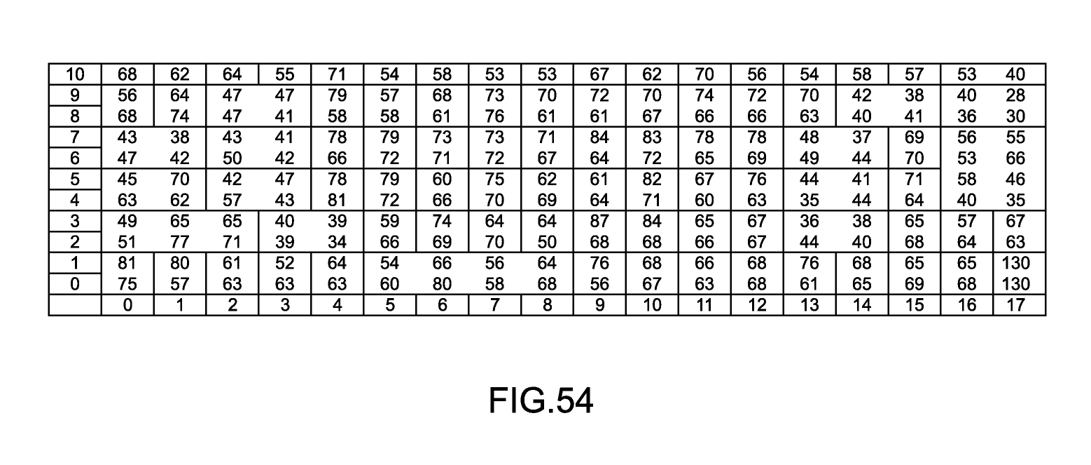

FIG. 54 shows an example of the threshold-value setting image in which second threshold values of the capacitive elements 71 included in the sensors 70, which are already changed, are displayed at predetermined cells. In the threshold-value setting image shown in FIG. 54, numerical values shown in the respective cells are changed to smaller values than those displayed in the cells of the threshold-value setting image shown in FIG. 53 on the whole. In this manner, the changing of the second threshold values of the sensors 70 to smaller values allows the controller c7 to determine a push state at a smaller amount of capacitance change, which makes it possible to increase the detection sensitivity of the sensors 70.

Further, as a specific operation of changing the second threshold values, for example, a method of directly inputting an instruction value into a cell corresponding to a sensor 70 that is intended to be changed may be used. Alternatively, a method of separately providing, on the threshold-value setting image, an input cell that is different from a cell corresponding to a sensor 70 and inputting into the input cell an instruction value such as an increment or decrement value of the second threshold value may be used. Information that is input in the input cell is reflected on the increment or decrement of the second threshold values of the plurality of sensors 70, which allows the second threshold values of the sensors 70 to be collectively incremented or decremented. For example, an increment or decrement value of the second threshold values is input separately for the sensors 70 arranged in a circumferential region of the input device 7 and for the sensors 70 arranged in the center of the input device 7, which leads to the increment or decrement of the second threshold values for each of those regions.

As described above, the electronic apparatus z7 according to this embodiment can change the threshold data based on an input operation of a user. Thus, for example, when a user who uses the electronic apparatus z7 wants a lighter operational feeling, the whole second threshold values can be changed to smaller values by the software described above to achieve a desired operational feeling. Further, for example, in the case where an operational feeling of a specific key is desired to be lighter for a game operation or the like, a second threshold value of a capacitive element 71 of a sensor 70 corresponding to the specific key can be changed by the software described above.

Further, the software described above may be downloaded from the Internet, for example, so that the upgrade thereof is achieved. Thus, the user-friendly software can be provided. Furthermore, using a server or the like on the Internet, a plurality of users can share various tuned information for use.

Although only the change of the second threshold values in the threshold data has been described in the above description, the first threshold values can also be changed in the same manner. Thus, even when the user intends to perform a touch operation in a light touch with a free edge of the nail of a pinky finger, for example, the touch operation is achieved by changing the whole first threshold values to smaller values.

In the above description, the change of the first and second threshold values to smaller values has been described. Conversely, the first and second threshold values may be changed to larger values. Thus, it is possible to set a touch state or a push state to be more difficult to detect, which makes it possible to prevent the occurrence of an erroneous operation, for example.

As described above, according to this embodiment, the detection sensitivity can be adjusted in accordance with an operation method of the user or characteristics of a user such as a pressing force. Therefore, the input operability for each user can be customized, with the result that an input device with higher operability for each user can be provided.

Further, in the above description, the personal computer has been described as an example of the electronic apparatus z7, but a modified example as follows may be employed.

(Information Processing Apparatus Including Tablet Terminal)

An example in which an information processing apparatus z71 including, for example, a tablet terminal z70 is applied to the electronic apparatus z7 according to this embodiment will be described.

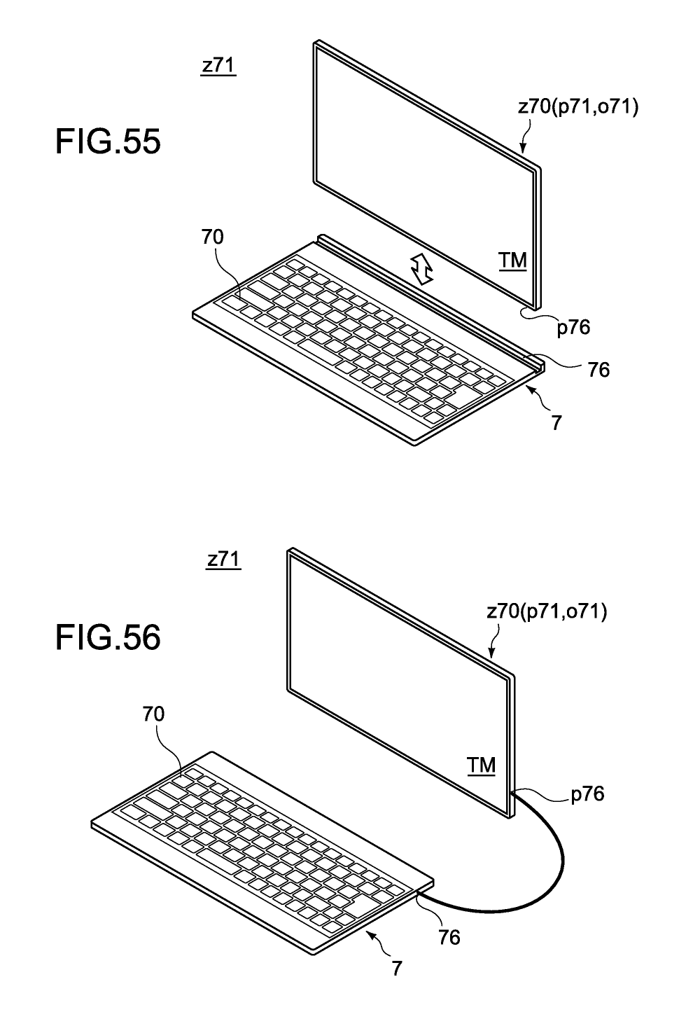

FIGS. 55 to 57 are schematic diagrams each showing the configuration of the input device 7 and the tablet terminal z70. The information processing apparatus z71 includes the input device 7 and the tablet terminal z70. The tablet terminal z70 further includes a processing device p71 serving as the processing device p7 and a display device o71 serving as the display device o7. The display device o71 includes a touch panel monitor TM. The touch panel monitor TM also serves as an input operation unit of the tablet terminal z70 and is configured to receive a touch operation of the user.

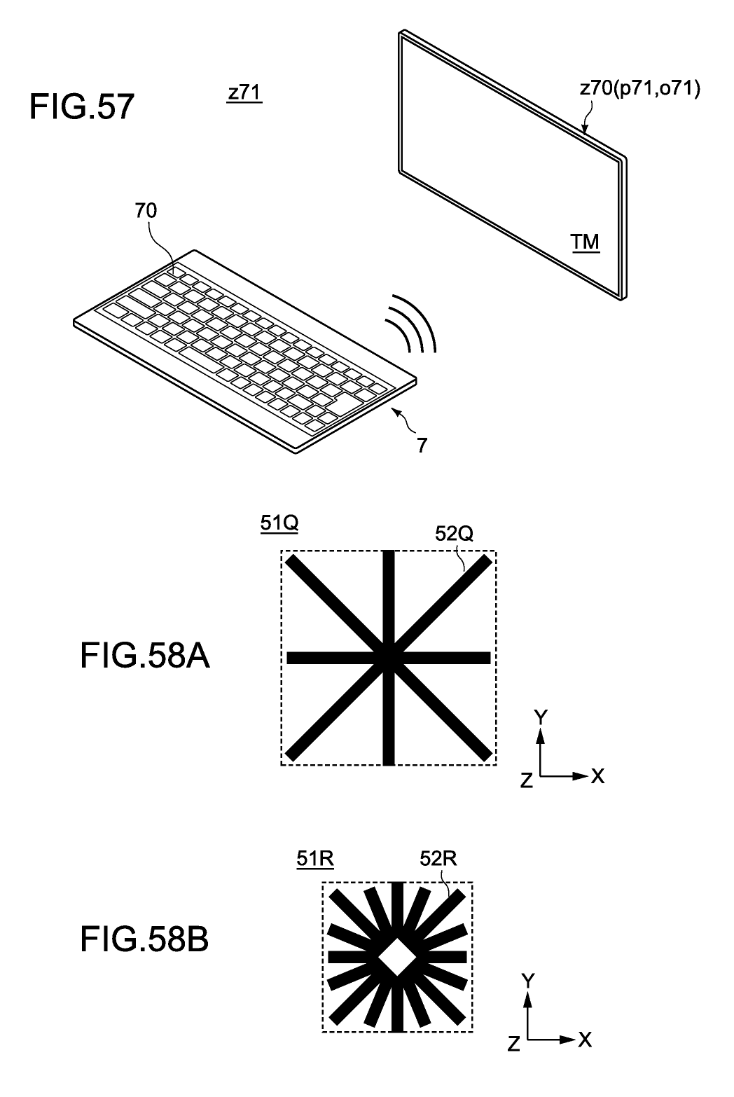

Here, the input device 7 and the tablet terminal z70 are electrically connected to each other via the communication unit 76 of the input device 7 and a communication unit p76 of the tablet terminal z70 (processing device p71). For example, FIG. 55 shows an example in which the input device 7 and the tablet terminal z70 are configured to be detachable from each other via input-output terminals. In this case, the communication unit 76 and the communication unit p76 include input-output terminals formed therein. On the other hand, FIG. 56 shows an example in which the input device 7 and the tablet terminal z70 are connected to each other by a cable through an USB terminal and the like. Further, FIG. 57 shows an example in which the input device 7 and the tablet terminal z70 are connected to each other by inter-device communications using radio waves, such as “Wi-Fi” (registered trademark), “ZigBee” (registered trademark), and “Bluetooth” (registered trademark).

In this modified example, the sensitivity adjustment software is stored in the storage p75 of the tablet terminal z70. For example, the sensitivity adjustment software is downloaded to the tablet terminal z70 from the Internet or the like via the communication unit p77, for example. Alternatively, the software may be installed from a recording medium such as a CD-ROM (Compact Disc-Read Only Memory). Thus, the user can operate the tablet terminal z70 to change threshold data that is stored in the storage 75 of the input device 7.

For example, the user activates the sensitivity adjustment software of the tablet terminal z70 to display a threshold-value setting image on the touch panel monitor TM. Then, a predetermined input operation is made on the touch panel monitor TM so that a sensitivity evaluation value displayed in the threshold-value setting image is changed.

The controller pc7 of the tablet terminal z70 generates a change command signal for changing the threshold data based on an input operation made on the touch panel monitor TM. The change command signal is output to the controller c7 of the input device 7 via the communication unit p76 and the communication unit 76.

The controller c7 of the input device 7 controls the storage 75 to change the threshold data stored in the storage 75 based on the change command signal. Thus, the threshold data is changed to a predetermined value through the input of the user.

The input operability for each user can also be customized in this modified example. The input device 7 according to this embodiment can change the key weight, that is, the detection sensitivity by only a parameter setting. Therefore, the download of the sensitivity adjustment software to the tablet terminal z70, which is a different device from the input device 7, also allows the key weight of the input device 7 to be changed.

Hereinabove, the embodiments of the present disclosure have been described, but the present disclosure is not limited to the embodiments described above and may be variously modified without departing from the gist of the present disclosure as a matter of course.

FIGS. 58A and 58B are diagrams each showing a modified example of the input device 5 according to the fifth embodiment described above, showing a configuration example of the X electrode 52 of the capacitive element 51. FIG. 58A shows an X electrode 52Q included in a capacitive element 51Q. FIG. 58B shows an X electrode 52R included in a capacitive element 51R. The X electrodes 52Q and 52R each have a different size and shape and substantially the same area. Thus, the initial capacitances of the capacitive elements 51Q and 51R can be set to be substantially the same.

For example, depending on the characteristics of the controller c5, in the case where the initial capacitance of each capacitive element 51 is significantly different from each other, a gain is difficult to adjust and a capacitive element 51 that does not normally operate may appear. Since the capacitive element 51 according to this embodiment of the present disclosure includes the X electrode 52 constituted of linear electrodes, the electrode area is easily controlled and the initial capacitance can be easily adjusted. Thus, even in the case where the capacitive elements 51Q and 51R each have a different size or the like as shown in the FIGS. 58A and 58B, the initial capacitances thereof can be set to be substantially the same, and the occurrence of the failure described above can be suppressed.

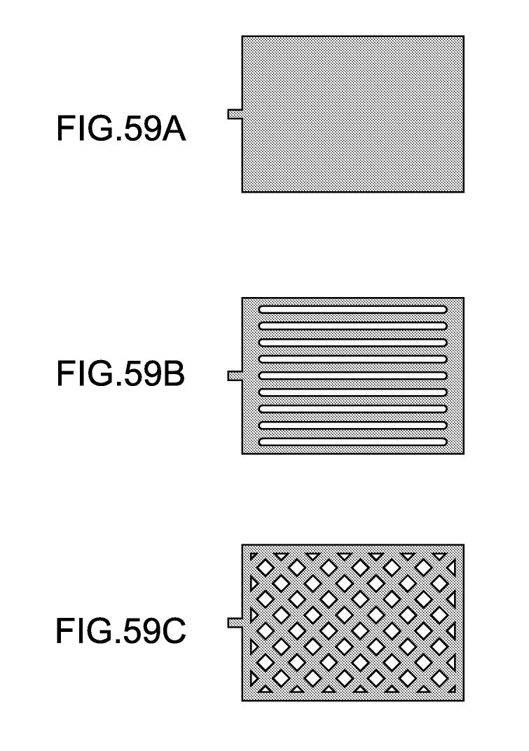

Further, FIGS. 59A to 59C are diagrams each showing a modified example of the input device 5 according to the fifth embodiment described above. FIG. 59A shows a configuration example of one planar electrode of the Y electrodes 53. On the other hand, FIGS. 59B and 59C each show an example of adopting an aggregate having linear electrodes that are relatively densely arranged, instead of the planar electrode. In the example shown in FIG. 59B, the Y electrode 53 is constituted of a lattice-shaped aggregate of linear electrodes. In the example shown in FIG. 59C, the Y electrode 53 is constituted of a mesh-like aggregate of linear electrodes. In this manner, the Y electrode 53 can exert a shielding effect even when it is constituted of an aggregate in which linear electrodes are relatively densely arranged.

Further, since the input device according to each of the embodiments described above adopts a capacitance system, an input operation of an operating element in a three-dimensional space can be detected. Thus, a so-called gesture operation such as a “swipe” operation or the like performed at a distance from the input operation unit can be detected. In the embodiments described above, for example, when the first threshold value is decreased to a value smaller than that of normal touch detection, such a gesture operation can also be easily detected.

For example, when the input device is configured to be transparent in the thickness direction and a display device serving as the output device is disposed on the surface that is opposite to the input operation unit, a touch panel display can be obtained. Thus, the operation can be made with a finger on the display device, with the result that a more intuitive operation can be made and the operability is significantly improved.

Further, in the embodiments described above, the input device has a flat-plate shape, but the shape thereof is not limited thereto. For example, the input device may be configured such that the input operation unit has a curved surface or may be configured such that the input device itself is deformable in the thickness direction thereof.

It should be noted that the present disclosure may adopt the following configurations.

(1) A sensor device, including:

a capacitive element having a first surface and being configured to change a capacitance thereof by an approach of an operating element to the first surface; and

an input operation unit arranged on the first surface, the input operation unit having a second surface on which an operation of the operating element is received and being configured to allow the operating element brought into contact with the second surface to move toward the first surface.

(2) The sensor device according to (1), in which

the second surface includes a plurality of concave portions.

(3) The sensor device according to (2), in which

the second surface is formed of an elastic material.

(4) The sensor device according to (1) or (2), in which

the input operation unit includes an elastic body that forms the second surface.

(5) The sensor device according to any one of (1) to (4), in which

the input operation unit is arranged between the first surface and the second surface and further includes a support portion configured to support the elastic body in an elastically deformable manner.

(6) An input device, including:

at least one sensor including
a capacitive element having a first surface and being configured to change a capacitance thereof by an approach of an operating element to the first surface, and
an input operation unit arranged on the first surface, the input operation unit having a second surface on which an operation of the operating element is received and being configured to allow the operating element brought into contact with the second surface to move toward the first surface; and

a controller including a determination unit configured to determine a first state and a change from the first state to a second state based on a change of the capacitance of the capacitive element, the first state being a state in which the operating element is in contact with the second surface, the second state being a state in which the operating element is pressing the second surface.

(7) The input device according to (6), in which

the determination unit is configured to determine the first state when an amount of capacitance change of the capacitive element is equal to or larger than the first threshold value, and determine the second state when the amount of capacitance change is equal to or larger than the second threshold value that is larger than the first threshold value.

(8) The input device according to (6) or (7), in which

the controller further includes a signal generation unit configured to generate an operation signal that is different between the first state and the second state.

(9) An input device, including:

a plurality of sensors each including
a capacitive element having a first surface and being configured to change a capacitance thereof by an approach of an operating element to the first surface, and
an input operation unit arranged on the first surface, the input operation unit having a second surface on which an operation of the operating element is received and being configured to allow the operating element brought into contact with the second surface to move toward the first surface; and

a controller configured to determine, for each of the plurality of sensors, a first state and a change from the first state to a second state based on a change of the capacitance of the capacitive element, the first state being a state in which the operating element is in contact with the second surface, the second state being a state in which the operating element is pressing the second surface.

(10) The input device according to (9), in which

the plurality of sensors include a plurality of sensors each having a different detection sensitivity of the capacitive element with respect to the approach of the operating element.

(11) The input device according to (10), in which

the plurality of sensors include a plurality of sensors each having a different number of capacitive elements.

(12) The input device according to any one of (9) to (11), in which

the capacitive element has a third surface opposed to the first surface,

the capacitive element includes

a first electrode disposed close to the first surface, and

a second electrode disposed close to the third surface to be opposed to the first electrode, and

the first electrode includes an aggregate of linear electrodes.

(13) The input device according to (12), in which

the second electrode includes a planar electrode.

(14) The input device according to any one of (9) to (13), in which

the controller is configured to determine, in units of the capacitive elements, the first state when an amount of capacitance change of the capacitive element is equal to or larger than a first threshold value and smaller than a second threshold value and determine, in units of the sensors to which the capacitive elements belong, the second state when the amount of capacitance change is equal to or larger than the second threshold value.

(15) The input device according to (14), in which

the plurality of sensors include a plurality of sensors each having a different second threshold value.

(16) The input device according to (15), further including a storage configured to store data on the first threshold value and the second threshold value that are unique to each of the plurality of sensors, in which

the controller is configured to control the storage to be capable of changing the data stored in the storage in response to an instruction from an outside.

(17) An electronic apparatus, including:

a capacitive element having a first surface and being configured to change a capacitance thereof by an approach of an operating element to the first surface;

an input operation unit arranged on the first surface, the input operation unit having a second surface on which an operation of the operating element is received and being configured to allow the operating element brought into contact with the second surface to move toward the first surface;

a controller including

a determination unit configured to determine a first state and a change from the first state to a second state based on a change of the capacitance of the capacitive element, the first state being a state in which the operating element is in contact with the second surface, the second state being a state in which the operating element is pressing the second surface, and

a signal generation unit configured to generate an operation signal that is different between the first state and the second state;

a processing device configured to generate a command signal based on the operation signal; and

an output device configured to perform output based on the command signal.

(18) The electronic apparatus according to (17), in which the output device includes a display device configured to display an image based on the command signal.
(19) An electronic apparatus, including:

a plurality of sensors each including

a capacitive element having a first surface and being configured to change a capacitance thereof by an approach of an operating element to the first surface, and

an input operation unit arranged on the first surface, the input operation unit having a second surface on which an operation of the operating element is received and being configured to allow the operating element brought into contact with the second surface to move toward the first surface;

a controller including

a determination unit configured to determine, for each of the plurality of sensors, a first state and a change from the first state to a second state based on a change of the capacitance of the capacitive element, the first state being a state in which the operating element is in contact with the second surface, the second state being a state in which the operating element is pressing the second surface, and

a signal generation unit configured to generate an operation signal that is different between the first state and the second state;

a processing device configured to generate a command signal based on the operation signal; and

an output device configured to perform output based on the command signal.

(20) The electronic apparatus according to (19), in which

the controller is configured to determine, in units of the capacitive elements, the first state when the amount of capacitance change of the capacitive element is equal to or larger than the first threshold value and smaller than the second threshold value, and determine, in units of the sensors to which the capacitive elements belong, the second state when the amount of capacitance change is equal to or larger than the second threshold value.

(21) The electronic apparatus according to (20), further including a storage configured to store data on the first threshold value and the second threshold value that are unique to each of the plurality of sensors, in which

the controller is configured to control the storage to be capable of changing the data stored in the storage in response to an instruction from an outside.

(22) An information processing method using an electronic apparatus including at least one sensor including

a capacitive element having a first surface and being configured to change a capacitance thereof by an approach of an operating element to the first surface, and

an input operation unit arranged on the first surface, the input operation unit having a second surface on which an operation of the operating element is received and being configured to allow the operating element brought into contact with the second surface to move toward the first surface, the information processing method including:

determining a first state in which the operating element is in contact with the second surface when an amount of capacitance change is equal to or larger than a first threshold value; and

determining a second state in which the operating element is pressing the second surface when the amount of capacitance change is equal to or larger than a second threshold value that is larger than the first threshold value.

(23) The information processing method according to (22), further including switching, based on an operation of a user, from an input operation mode in which the first state and the second state are determined to a change mode in which the second threshold value is changed.
(24) The information processing method according to (23), in which

the at least one sensor includes a plurality of sensors, and

the switching to the change mode includes changing the second threshold value of a part of the sensors to a value different from the second threshold values of the other sensors.

(25) The information processing method according to (24), in which

the changing the second threshold value includes receiving an input on the second threshold value of the part of the sensors and changing the second threshold value based on an input instruction value.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A sensor device, comprising:
a capacitive element having a first surface and being configured to change a capacitance thereof by an approach of an operating element to the first surface; and
an input operation unit arranged on the first surface, the input operation unit having a second surface on which an operation of the operating element is received and being configured to allow the operating element brought into contact with the second surface to move toward the first surface.

2. The sensor device according to claim 1, wherein
the second surface includes a plurality of concave portions.

3. The sensor device according to claim 2, wherein
the second surface is formed of an elastic material.

4. The sensor device according to claim 1, wherein
the input operation unit includes an elastic body that forms the second surface.

5. The sensor device according to claim 4, wherein
the input operation unit is arranged between the first surface and the second surface and further includes a support portion configured to support the elastic body in an elastically deformable manner.

6. An input device, comprising:
at least one sensor including
a capacitive element having a first surface and being configured to change a capacitance thereof by an approach of an operating element to the first surface, and
an input operation unit arranged on the first surface, the input operation unit having a second surface on which an operation of the operating element is received and being configured to allow the operating element brought into contact with the second surface to move toward the first surface; and
a controller including a determination unit configured to determine a first state and a change from the first state to a second state based on a change of the capacitance of the capacitive element, the first state being a state in which the operating element is in contact with the second surface, the second state being a state in which the operating element is pressing the second surface.

7. The input device according to claim 6, wherein
the determination unit is configured to determine the first state when an amount of capacitance change of the capacitive element is equal to or larger than a first threshold value, and determine the second state when the amount of capacitance change is equal to or larger than a second threshold value that is larger than the first threshold value.

8. The input device according to claim 7, wherein
the at least one sensor includes a plurality of sensors, and
the plurality of sensors include a plurality of sensors each having a different second threshold value.

9. The input device according to claim 8, further comprising a storage configured to store data on the first threshold value and the second threshold value that are unique to the at least one sensor, wherein
the controller is configured to control the storage to be capable of changing the data stored in the storage in response to an instruction from an outside.

10. The input device according to claim 6, wherein
the controller further includes a signal generation unit configured to generate an operation signal that is different between the first state and the second state.

11. The input device according to claim 6, wherein
the at least one sensor includes a plurality of sensors, and
the plurality of sensors include a plurality of sensors each having a different detection sensitivity of the capacitive element with respect to the approach of the operating element.

12. The input device according to claim 11, wherein
the plurality of sensors each having a different detection sensitivity each have a different number of capacitive elements.

13. An electronic apparatus, comprising:
at least one sensor including
a capacitive element having a first surface and being configured to change a capacitance thereof by an approach of an operating element to the first surface, and
an input operation unit arranged on the first surface, the input operation unit having a second surface on which an operation of the operating element is received and being configured to allow the operating element brought into contact with the second surface to move toward the first surface;
a controller including
a determination unit configured to determine a first state and a change from the first state to a second state based on a change of the capacitance of the capacitive element, the first state being a state in which the operating element is in contact with the second surface, the second state being a state in which the operating element is pressing the second surface, and
a signal generation unit configured to generate an operation signal that is different between the first state and the second state;
a processing device configured to generate a command signal based on the operation signal; and
an output device configured to perform output based on the command signal.

14. The electronic apparatus according to claim 13, wherein
the output device includes a display device configured to display an image based on the command signal.

15. The electronic apparatus according to claim 13, wherein
the controller is configured to determine the first state when the amount of capacitance change of the capacitive element is equal to or larger than the first threshold value and smaller than the second threshold value, and determine the second state when the amount of capacitance change is equal to or larger than the second threshold value.

16. The electronic apparatus according to claim 15, wherein
the at least one sensor includes a plurality of sensors,
the electronic apparatus further includes a storage configured to store data on the first threshold value and the second threshold value that are unique to each of the plurality of sensors, and
the controller is configured to control the storage to be capable of changing the data stored in the storage in response to an instruction from an outside.

17. An information processing method using an electronic apparatus including at least one sensor including
a capacitive element having a first surface and being configured to change a capacitance thereof by an approach of an operating element to the first surface, and
an input operation unit arranged on the first surface, the input operation unit having a second surface on which an operation of the operating element is received and being configured to allow the operating element brought into contact with the second surface to move toward the first surface, the information processing method comprising:
determining a first state in which the operating element is in contact with the second surface when an amount of capacitance change is equal to or larger than a first threshold value; and
determining a second state in which the operating element is pressing the second surface when the amount of capacitance change is equal to or larger than a second threshold value that is larger than the first threshold value.

18. The information processing method according to claim 17, further comprising switching, based on an operation of a user, from an input operation mode in which the first state and the second state are determined to a change mode in which the second threshold value is changed.

19. The information processing method according to claim 18, wherein
the at least one sensor includes a plurality of sensors, and
the switching to the change mode includes changing the second threshold value of a part of the sensors to a value different from the second threshold values of the other sensors.

20. The information processing method according to claim 19, wherein
the changing the second threshold value includes receiving an input on the second threshold value of the part of the sensors and changing the second threshold value based on an input instruction value.
